(19) United States
(12) Patent Application Publication
(10) Pub. No.: US 2026/0178091 A1
(43) Pub. Date: Jun. 25, 2026

(54) SYSTEM AND METHOD FOR WORKLOAD-AWARE FACILITY CONTROL

(71) Applicant: Phaidra Inc., Seattle, WA (US)

(72) Inventors: Kenzo Spaulding, Seattle, WA (US); Vedavyas Panneershelvam, Bumaby (CA); Timothy Cheadle, Seattle, WA (US); Christopher R. Vause, Austin, TX (US)

(73) Assignee: Phaidra Inc., Seattle, WA (US)

(21) Appl. No.: 19/427,285

(22) Filed: Dec. 19, 2025

Related U.S. Application Data
(60) Provisional application No. 63/737,494, filed on Dec. 20, 2024.

(51) Int. Cl. G06F 1/20; G06F 9/50

(52) U.S. Cl. CPC G06F 1/206; G06F 9/5094; G06F 2209/5019

(57) ABSTRACT

Variants of the system includes an industrial facility, job scheduling services, and a set of control agents configured to manage power and cooling resources. The method includes determining a current system state, optionally predicting a future system state, determining control setpoints, and controlling the facility based on the setpoints. In a data center implementation, the control agents receive physical state information from infrastructure components and job data from the job scheduling services. Using this information, the control agents predict future power and heat loads associated with scheduled compute jobs. The predictions are generated by a state approximator. Based on the predicted resource demands, the control agents determine control setpoints for cooling and power infrastructure components. The job scheduling services can allocate, delay, or reschedule jobs based on predicted thermal and power constraints.

### CROSS-REFERENCE TO RELATED APPLICATIONS

This application claims the benefit of US Provisional Application number 63/737,494 filed 20-DEC-2024, which is incorporated in its entirety by this reference.

### TECHNICAL FIELD

This invention relates generally to the facility control field, and more specifically to a new and useful workload-aware facility control systems and methods in the facility control field.

### BRIEF DESCRIPTION OF THE SEVERAL VIEWS OF THE DRAWINGS

FIG. 1 is a schematic representation of a variant of the industrial facility.

FIG. 2 is a schematic representation of a variant of the control system.

FIG. 3 is a schematic representation of a variant of the industrial facility.

FIG. 4 is a schematic representation of variants of the industrial facility control system.

FIG. 5 is a schematic representation of a variant of the method.

FIG. 6 is a schematic representation of a specific example of the system and method.

### DETAILED DESCRIPTION OF THE INVENTION

The following description of the embodiments of the invention is not intended to limit the invention to these embodiments, but rather to enable any person skilled in the art to make and use this invention.

### Overview

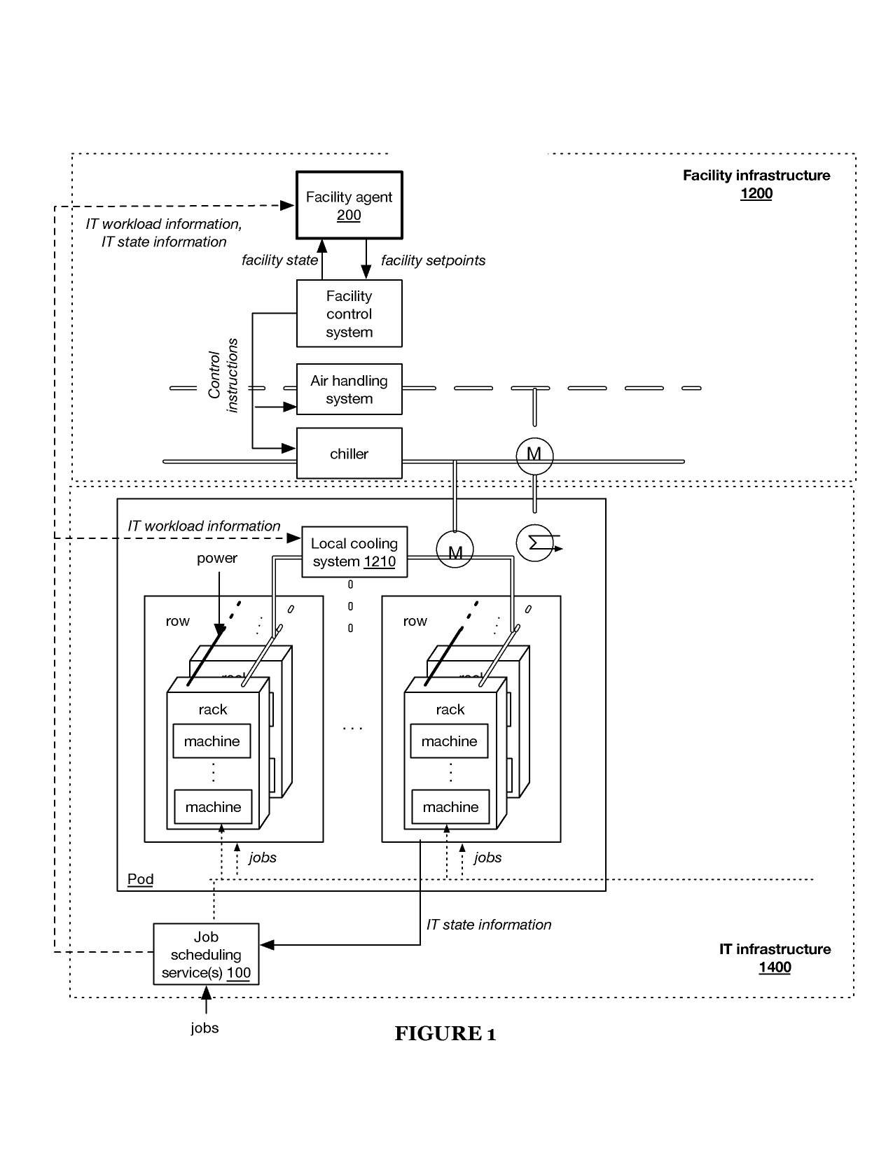

As shown in FIG. 1, the system includes: an industrial facility 1000; a set of job scheduling services 100; and a set of agents 200; and/or any other suitable components. The method can include: determining a system state S100; optionally predicting a future system state S200; determining a set of setpoints S300; controlling the system S400; and optionally training the models used by the agents S1000; and/or any other suitable steps.

In an illustrative example, the control system for a data center can include system controllers, job scheduling services, and a set of control agents. The control agent(s) can include a state approximator for predicting a future power and/or heat load based on: the physical state of components of the data center (e.g., supply temperature, return temperature, computing device temperature, past load demands, external factors, other operational technology states, etc.), job data associated with compute jobs (e.g., software computational jobs, compute workloads, etc.) received by the job scheduling services (e.g., job type, allocated CPUs and GPUs, requested CPUs and/or GPUs, other information technology states, etc.), and/or network availability. The state approximator can be a model (e.g., machine learning model, physics-based model, etc.) that estimates a future resource demand (e.g., thermal load, power consumption, etc.) based on the physical state and/or the job information (e.g., or encodings thereof) . The control agent(s) can additionally include a decision model (e.g., learned policies, trained neural networks, etc.) that determine control setpoints (e.g., temperature setpoints, flow rates, number of OT components to operate, etc.) based on the predictions. The job scheduling services can optionally allocate, schedule, and/or delay jobs based on the predictions. The controller can control the data center infrastructure (e.g., chillers, fans, valves, pumps, CDUs, etc.) based on the determined setpoints.

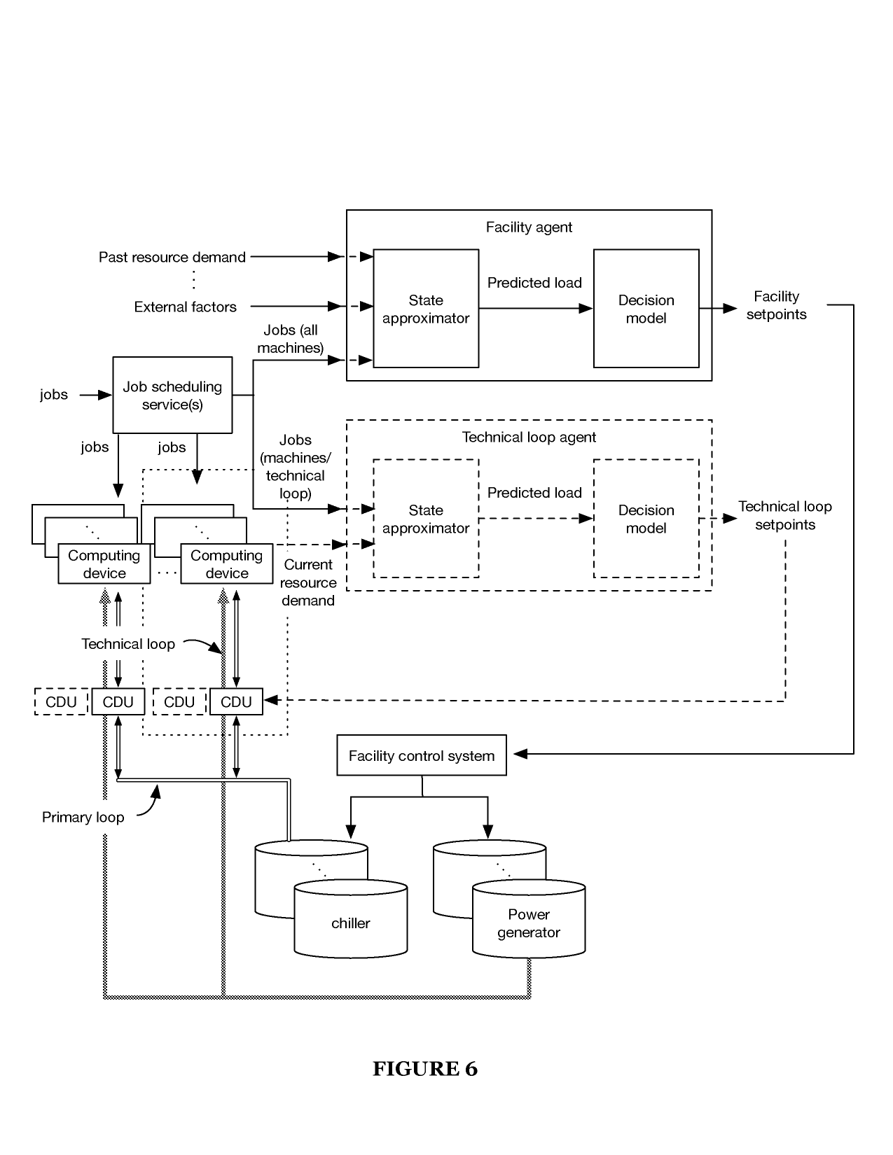

In specific examples, the set of control agents can include a facility agent configured to control the base OT infrastructure (e.g., chillers, power generators, etc.) based on system-wide facility setpoints (e.g., number of chillers, number of generators, setpoints for resources leaving the resource sources, etc.) predicted from overall job data, overall computing system physical states, historical resource demands, and external factors. An example is shown in FIG. 6.

In these examples, the set of control agents can optionally include a set of technical loop agents (local agents) configured to control individual technical loops (e.g., a set of CDUs and connected computing devices) based on technical loop setpoints (e.g., secondary supply temperature setpoints for individual CDUs) predicted from technical loop specific job data (e.g., future scheduled workload) and technical loop specific physical states (e.g., power demand). An example is shown in FIG. 6.

### Technical advantages

Variants of the technology can confer one or more advantages over conventional technologies.

First, variants of the technology determine cooling setpoints based on predicted heat loads derived from job scheduling data, which enables pre-emptive thermal control of data center resources. In particular, the predicted heat loads are computed using information associated with scheduled jobs prior to execution, such that cooling actions can be initiated in advance of the corresponding compute activity. By leveraging job-level data rather than relying solely on temperature sensor feedback, thermal lag can be reduced and localized temperature excursions (e.g., hotspots within racks, aisles, or zones) can be mitigated relative to reactive cooling approaches that respond only after heat generation has occurred. This job-data-driven predictive control can maintain temperatures within desired operating ranges more consistently during workload transitions and can reduce reliance on conservative thermal margins. Preemptive thermal resource provision can also ensure that each set of computing devices has sufficient cooling resources available to sink the generated heat, which can prevent computing devices from overheating and throttling the jobs being executed on said machine.

Second, variants of the technology can improve energy efficiency of cooling resources by reducing rapid ramp-up events and peak cooling demand. For example, pre-emptive cooling based on predicted workloads can reduce compressor cycling, fan overspeeding, and abrupt changes in cooling output, thereby lowering overall energy consumption while maintaining operating temperatures within target bounds. In some variants, smoother cooling profiles can also improve part-load efficiency of cooling equipment and reduce transient inefficiencies associated with sudden load changes.

Third, variants of the technology can enable coordinated control of power resources and cooling resources within a data center. By jointly determining setpoints for power infrastructure (e.g., generators, UPS systems, power distribution equipment, etc.) and cooling infrastructure (e.g., chillers, HVAC units, CRAC units, CRAH units, CDUs), the system can align thermal demand with available electrical capacity and operational constraints. This coordination can reduce conflicts between power delivery limits and cooling requirements, particularly during periods of high or rapidly changing workload demand.

Fourth, variants of the technology can enable resource-aware job scheduling that accounts for both predicted power availability and spatial thermal capacity. For example, jobs can be scheduled, deferred, or allocated to specific zones of a data center based on localized cooling capability and predicted heat generation, thereby preventing execution of workloads that would exceed thermal or power constraints in particular regions. This approach can improve utilization of under-used zones while avoiding concentration of heat-intensive jobs in thermally constrained areas.

Fifth, variants of the technology can improve power demand shaping by coordinating job execution with cooling demand over time. By anticipating upcoming workloads and associated heat loads, power draw can be smoothed, peak demand can be reduced, and compatibility with constrained power budgets or on-site generation resources can be improved. In some variants, this coordination can reduce short-duration power spikes associated with simultaneous workload initiation and cooling ramp-up events.

However, further advantages can be provided by the system and method disclosed herein.

### System

In variants, the system includes: an industrial facility 1000; a set of job scheduling services 100; and a set of agents 200. The system functions to provide workload-aware facility control. In examples, the system can enable workloads (e.g., compute jobs, processing jobs, etc.) to be allocated in light of facility-level resource availability and/or using facility-level optimizations. In examples, the industrial facility control system can enable workloads (e.g., compute jobs, processing jobs, etc.) to be allocated in light of facility-level resource availability and/or using facility-level optimizations. For example, the facility resource availability and system states (e.g., local temperatures, computing device temperatures, etc.) can inform and/or be used to determine the prioritization of jobs, allocation of jobs, and/or any other job-related task. In examples, the industrial facility control system can enable the facility agent(s) to account for current and future workloads (e.g., jobs, traffic, etc.) and/or any other suitable workload types. For example, the current and future workload can be used to determine resource operation, facility setpoints, and/or operational parameters (e.g., power source utilization, environmental control setpoints, temperature setpoints, chiller setpoints, flow rates, differential pressures, etc.) for controlling the facility.

The system can be used with an industrial facility and/or any other suitable industrial application. The industrial facility control system can include a set of agents, a set of job scheduling services, and/or any other suitable components. In an illustrative example, the system can be a control system for a data center that can include system controllers, job scheduling services, and a set of control agents. The control agent(s) can include a state approximator for predicting a future power and/or heat load based on: the physical state of components of the data center (e.g., supply temperature, return temperature, computing device temperature, past load demands, external factors, other operational technology states, etc.), based on job data associated with compute jobs (e.g., software computational jobs, compute workloads, etc.) received by the job scheduling services (e.g., job type, allocated CPUs and GPUs, requested CPUs and/or GPUs, other information technology states, etc.). The state approximator can be a model (e.g., machine learning model, physics-based model, etc.) that estimates a future resource demand (e.g., thermal load, power consumption, etc.) based on the physical state and/or the job information (e.g., or encodings thereof). The control agent(s) can additionally include a decision model (e.g., learned policies, trained neural networks, etc.) that determine control setpoints (e.g., temperature setpoints, flow rates, number of OT components to operate, etc.) based on the predictions. The job scheduling services can optionally allocate, schedule, and/or delay jobs based on the predictions. The controller can control the data center infrastructure (e.g., chillers, fans, valves, pumps, CDUs, etc.) based on the determined setpoints. In specific examples, the set of control agents can include a facility agent configured to control the base OT infrastructure (e.g., chillers, power generators, etc.) based on system-wide facility setpoints (e.g., number of chillers, number of generators, setpoints for resources leaving the resource sources, etc.) predicted from overall job data, overall computing system physical states, historical resource demands, and external factors. An example is shown in FIG. 6. In these examples, the set of control agents can optionally include a set of technical loop agents (local agents) configured to control individual technical loops (e.g., a set of CDUs and connected computing devices) based on technical loop setpoints (e.g., secondary supply temperature setpoints for individual CDUs) predicted from technical loop specific job data (e.g., future scheduled workload) and technical loop specific physical states (e.g., power demand). An example is shown in FIG. 6.

The industrial facility control system can control an industrial facility 1000. The industrial facility 1000 is preferably an IT facility, and more preferably a data center, but can alternatively be a regional cluster, a global network, a data hall, and/or any other suitable industrial facility type. An example of the industrial facility 1000 is shown in FIG. 1. In variants, the industrial facility 1000 includes the facility infrastructure 1200, the information technology infrastructure 1400, and/or any other suitable components.

The facility infrastructure 1200 functions to physically support IT infrastructure operation, including managing thermal load, providing power, and/or any other suitable physical support operations. The facility infrastructure 1200 preferably includes physical systems (e.g., mechanical systems, electrical systems, thermal systems, etc.), but can alternatively include any other suitable infrastructure components. In variants, the facility infrastructure 1200 can be organized in a hierarchical structure (e.g., taxonomy). In variants, the hierarchy can include variables, setpoints, measured parameters, and/or any other values associated with different components (e.g., chillers, coolers, power supply, computing devices, CDUs, etc.). The hierarchy can include a power domain (e.g., relating to power consumption), cooling domain (e.g., related to temperature control), and/or any other domains. In variants, the hierarchy can be organized as graph structures, where nodes represent different components and/or variables, and connectors define their relationships. The graph structure can be utilized by the agent when determining setpoints and/or making predictions.

In variants, the facility infrastructure 1200 includes facility infrastructure subsystems and the facility control systems. The facility infrastructure subsystems (e.g., operational technology infrastructure) can include one or more cooling systems, power systems, environmental controls, and/or any other suitable subsystems. The cooling systems can include chillers and air handling systems such as computer room air handlers (CRAHs, etc.). The cooling systems can include cooling sources (e.g., cooling resources; chillers, CRACs / CRAHs, etc.), cooling loops (e.g., primary loop, technical or secondary loops, etc.), thermal sinks, and/or other thermal management components. In an example, a technical loop (secondary loop) can include one or more CDUs, wherein each CDU can control coolant supply to one or more computing devices. All or a subset of the technical loops can be connected to (e.g., supplied by) the same primary loop. Each cooling source or type thereof can be associated with a staging duration (e.g., time to bring up the cooling source) and/or shutdown duration. The power systems can include uninterruptible power supplies, power distribution units, power generators, and/or other power systems. The power generators can include combustion powered generators, hydroelectric generators, wind generators, heat pumps, and/or other generators. Each generator or type thereof can be associated with a staging duration (e.g., time to bring up the generator) and/or shutdown duration. The environmental controls can include humidity regulation, fire suppression, air circulation, and/or other environmental controls (e.g., etc.). Each facility infrastructure subsystem can include pumps (e.g., heat pumps, fluid pumps, etc.), heat exchangers, fans, heating units, cooling units (e.g., Peltier pumps, heat pumps, chillers, etc.), valves, plenums, sensors (e.g., temperature, pressure, flow rate, humidity, etc.), and/or any other suitable components.

In an example, a chiller controls facility-level cooling, while CRAHs control room-level cooling. The CRAHs can be thermally connected to the chiller loop (e.g., blow air over an exposed surface of the chiller loop to cool the room, dump heat into the chiller loop, etc.), or be otherwise thermally connected to the chiller loop. The facility infrastructure subsystems can be otherwise configured.

However, the facility infrastructure subsystems may be otherwise configured.

The facility control systems function to control the facility infrastructure. Examples of facility control systems that can be used can include data center infrastructure management systems (DCIM systems), local control systems (LCS), building management systems (BMS) (e.g., that control the environment conditioning system), electrical power monitoring and/or management system (EPMS), and/or any other suitable control systems. The facility control systems are preferably run locally, but can alternatively be run remotely. The facility control systems can run on a server, CPU, GPU, microprocessor, ASIC, cluster, and/or any other suitable computing platform.

An industrial facility can include one or more facility control systems. Each facility control system can be specific to and control a different facility subsystem, and/or alternatively control multiple facility subsystems. In a first example, the facility control systems can include a cooling control system that controls all cooling subsystem components and a power control system that controls all the power subsystem components. In a second example, the facility infrastructure can include a chiller control system that controls the chillers and an air handling control system that controls the air handling subsystem. Different instances of the same subsystem type can be controlled by the same facility control system and/or different facility control systems.

Each facility control system can generate low-level control instructions (e.g., pump voltage, pump rate, cooling unit voltage or current, etc.) for the respective facility component or group thereof. The control instructions are preferably generated based on the current state of the controlled facility component set (e.g., system state) and/or a target setpoint (e.g., operating target), but can alternatively be generated according to a schedule or otherwise generated. In examples, the target setpoints can include target measurement values, target component states, target measurement rates of change, differential pressure setpoint for pumps, supply temperature setpoint for cooling systems, return temperature setpoint for cooling systems (e.g., leaving chilled water temperature), valve positions for primary and secondary cooling loops, number of running chillers, number of running power generators, and/or any other suitable setpoints.

The control instructions can be generated based on the current state of the controlled facility component set (e.g., system state) and/or a target setpoint (e.g., operating target), but can alternatively be generated according to a schedule or otherwise generated. For example, the facility control system iteratively modulates the chiller power and/or valves until the measured temperature substantially meets a temperature setpoint.

The target setpoints are preferably determined by the set of agents, but can alternatively be generated by the facility control systems, received from a user, and/or otherwise determined. In variants, control instructions can be determined (e.g., generated, computed, etc.) based on the facility workload (e.g., jobs, traffic, etc.), predicted system states (e.g., determined using predictive models, etc.), historical system states, and/or other information. The facility control systems can optionally generate setpoints (e.g., operating targets) in addition to generating low-level control instructions, but can alternatively not generate setpoints and/or any other suitable control parameters.

The facility control systems can include: a proportional-integral-derivative (PID) controller (e.g., that react to deviations in supply temperature from control setpoints), cascaded PID controllers, proportional-integral (PI) controllers, proportional controllers, model predictive controllers (MPC), fuzzy logic controllers, adaptive controllers, feed-forward controllers, cascade controllers, ratio controllers, selective controllers, split-range controllers, programmable logic controllers (PLC), distributed control systems (DCS), supervisory control and data acquisition (SCADA) systems, building automation systems (BAS), direct digital controllers (DDC), and/or any other suitable control systems.

However, the facility control systems and the facility infrastructure 1200 may be otherwise configured.

The information technology infrastructure 1400 functions to run workloads, process data, store data, transmit data, and/or any other suitable data operations. The information technology infrastructure 1400 can include the computational equipment and the software stack hosted by the industrial facility (e.g., data center). In examples, workloads that can be supported by (e.g., run by, executed by, etc.) the information technology infrastructure can include web applications, database transactions, machine learning computations (e.g., training, inference, etc.), video streaming, email hosting, file storage operations, virtual desktop infrastructure (VDI), data analytics processing, enterprise resource planning (ERP) systems, high-performance computing (HPC) tasks, and/or any other suitable workloads. The information technology infrastructure 1400 preferably operates within a physical environment managed by facility infrastructure, but can additionally and/or alternatively be otherwise configured. In an illustrative example, a rack can be thermally connected (e.g., via convection, radiation, etc.) to the cooling systems of the facility infrastructure (e.g., the ambient environment controlled by the air handling system, the chiller loop controlled by the chiller system, etc.). The facility infrastructure can manage the thermal load output by the information technology infrastructure 1400.

In variants, the information technology infrastructure 1400 includes the set of computing devices 1410. The set of computing devices 1410 functions to process workloads (e.g., jobs). The set of computing devices (e.g., machines, etc.) can include physical machines, bare metal machines, other processing systems, and/or any other suitable machines. Examples of machines that can be used include a GPU, a CPU, a TPU, an IPU, a microprocessor, a server, and/or any other suitable processing system. The set of computing devices can additionally or alternatively include storage systems, networking (e.g., Tor switches, core routing), and/or any other computing devices. In examples, the set of computing devices 1410 can have a thermal design power rating (TDP rating), which represents the maximum amount of heat generated by a processing unit. The TDP rating can be used as a thermal assumption when planning workloads, even if the jobs do not physically generate that much heat when executed.

The set of computing devices 1410 can be organized into a hierarchy of control domains (e.g., machine subsets, machine groups, etc.). The hierarchy can include a single machine (e.g., individual computing unit), a rack (e.g., group of machines mounted to a common physical enclosure), a row (e.g., group of racks with shared infrastructure, such as cooling or power, etc.), a pod (e.g., group of collocated rows), a zone or region (e.g., groups of collocated pods), a data hall (e.g., large room with multiple zones), a data center (e.g., facility with one or more data halls), and/or a regional center set (e.g., geographical region with multiple data centers).

The set of computing devices 1410 can be powered by a set of power distribution units (e.g., providing 120V 3-phase AC power), and/or can alternatively be otherwise powered by any other suitable power source.

The set of computing devices can be cooled by a liquid cooling system (e.g., managed by a CDU, cooled by the chiller system of the facility infrastructure, etc.), ambient air (e.g., managed by the air handling system of the facility infrastructure), and/or otherwise cooled by any other suitable cooling method. In a specific example, different subsets of computing devices can be cooled by different technical loops. The subsets are preferably distinct (e.g., nonoverlapping), but can alternatively overlap. In variants, the machine groups and/or subsets can be organized such that they are cooled by the liquid cooling system in parallel, in series, and/or any other configuration. In variants, the set of computing devices 1410 can be cooled by local cooling devices, such as cooling distribution units (CDUs) and/or any other cooling devices. The CDUs can include a CDU coolant path, a heat sink and/or heat exchanger (e.g., in thermal connection with a primary chiller line and the CDU coolant path, etc.), and/or any other suitable components. The CDUs can have a set of valves, pumps, and/or any other actuator mechanisms that can control the flow of coolant (e.g., volumetric flow rate, mass flow rate, flow speed, etc.). The coolant can include water, glycol (e.g., ethylene glycol, propylene glycol, triethylene glycol, etc.), dielectric coolants, mixtures thereof, and/or any other coolants.

However, the set of computing devices 1410 may be otherwise configured.

However, the information technology infrastructure 1400 may be otherwise configured.

However, the industrial facility 1000 may be otherwise configured.

The set of job scheduling services 100 functions to distribute the computational workload across the set of computing devices (e.g., by assigning jobs to machines or groups thereof). The job scheduling service can distribute incoming network traffic across multiple machines to ensure optimal resource utilization, maximize throughput, minimize response time, and/or prevent machine overload. The job scheduling service can actively monitor machine health, automatically redirect traffic away from failed machines, and/or dynamically adjust traffic distribution based on real-time machine performance metrics. The job scheduling service can include any other suitable features and/or capabilities for managing network traffic distribution and/or machine resources. The industrial facility control system can include one or more job scheduling services of the same or different type and/or any other suitable service configuration.

The set of job scheduling services can include load balancers, workload managers, schedulers (e.g., cluster schedulers, job schedulers, etc.), resource managers, orchestrators (e.g., machine-specific orchestrators, job orchestrators, etc.), monitoring systems, and/or any other suitable components.

In an example, the set of job scheduling services can include SLURM schedulers, HPC schedulers, and/or any other schedulers. Each job scheduling service can control workload allocation to a specific machine subset (e.g., machine group, such as zone, pod, row, rack, individual machine, etc.), but can alternatively control workload allocation to the entire machine set. The set of job scheduling services 100 can be hierarchical (e.g., different job scheduling services for each hierarchical machine group), but can alternatively be flat and/or any other suitable configuration. The job scheduling service can be integrated into the facility agent, incorporate the facility agent, remain separate services, and/or any other suitable configuration. In variants, the job scheduling services can coordinate how jobs are submitted, queued, scheduled, prioritized, run across the information technology infrastructure, and/or otherwise performed. In variants, the job scheduling service can receive job requests, submissions, cancellations, holds, and/or any other input for compute jobs (e.g., executables, scripts, etc.). The set of job scheduling services 100 can receive batch jobs, interactive jobs, array jobs, parallel jobs, and/or other suitable job types.

The computational jobs managed by the job scheduling services can include parameters such as job identification (e.g., jobID), job name (e.g., JobName), number of allocated CPUs (e.g., AllocCPUs, NCPUS), number of allocated nodes (e.g., AllocNodes, NNodes, etc.), allocated trackable resources (e.g., AllocTRES), list of node hostnames (e.g., NodeList), requested number of CPUs (e.g., ReqCPUS), request number of nodes (e.g., ReqNodes), number of trackable resources requested (e.g., ReqTRES), number of restarts (e.g., after a failure), state of the job (e.g., pending, running, completed, failed, cancelled, timeout, etc.), submit time, start time, end time, status and/or exit code, and/or any other job scheduling data.

The job scheduling service can allocate jobs to machines based on machine metrics such as machine response time, current machine load, current machine group load (e.g., rack load, row load, pod load, etc.), number of active connections, machine health status, geographic location of clients, session persistence requirements, resource availability (CPU, memory, bandwidth), queued requests per machine, machine weightage, connection throttling limits, specific application performance metrics to optimize workload distribution across available resources, and/or any other suitable machine metrics or IT infrastructure state parameters.

The job scheduling service can control job allocation based on computing resource availability (e.g., GPU availability, memory availability, network congestion, etc.), accelerator type (e.g., GPU, TPU, FPGA, etc.), job placement constraints (e.g., affinity / anti-affinity), facility resource availability (e.g., cooling availability, power availability, etc.), facility agent-provided IT constraints (e.g., overall resource envelopes, resource envelopes for a given machine group, etc.), facility agent-provided IT setpoints (e.g., job allocation, job schedule, number of machines to allocate jobs to, etc.), facility agent-provided IT control signals (e.g., allocate more jobs, less jobs, no jobs, shed jobs, etc.), facility state (e.g., ambient temperature, wet-bulb temperatures, etc. of rooms, regions, sections of the facility) and/or any other suitable control parameters. The job scheduling service can allocate jobs using round-robin distribution (e.g., which cyclically assigns tasks to each machine in sequence, etc.), using a least connection method (e.g., which routes new jobs to machines with the fewest active connections, etc.), using weighted distribution (e.g., which assigns tasks based on predefined machine capabilities, etc.), using dynamic load allocation (e.g., which considers real-time metrics such as CPU utilization, memory usage, and response times to make routing decisions, etc.), and/or any other suitable allocation methods.

In variants, the job scheduling services can ensure that jobs are submitted, scheduled, allocated (e.g. assign jobs to specific resources), executed, and/or any otherwise controlled. The duration of each step of the process can be dependent on the job, the requested resources, the resource availability, and/or any other factor. For example, jobs with larger amounts of requested resources may take longer to run. In variants, the time between scheduling and allocating the job can be between 5 seconds and 10 minutes (e.g., 5 seconds, 10 seconds, 15 seconds, 20 seconds, 25 seconds, 30 seconds, 1 minute, 2 minutes, 3 minutes, 4 minutes, 5 minutes, 10 minutes, or any range and/or value therebetween). The time between scheduling and allocating the job can alternatively be less than 5 seconds or greater than 10 minutes. However, the job scheduling service tasks can have any other suitable timing. In some variants, the job scheduling service can receive operational resource control signals (e.g., from the set of agents) and schedule workloads based on the operational resource control signals. This can prevent the job scheduling service from making assumptions about cooling capacity that lead to stranded power or uncontrolled throttling (e.g., by ensuring that job dispatching approximately matches the amount of operational resources, such as cooling or power, that are available).

In some variants, the job scheduling services can include a set of job schedulers, a job scheduler manager (e.g., Base Command Manager (BCM)), and/or any other suitable components. For example, the set of job schedulers can be configured to generate, queue, prioritize, and execute jobs associated with one or more system functions, while the job scheduler manager can be configured to coordinate operation of the set of job schedulers, including assigning jobs to individual job schedulers, resolving scheduling conflicts, enforcing execution policies, and managing job lifecycles across the job scheduling services. In some variants, the job scheduler manager can provide a set of interfaces for querying and/or receiving information about the workloads and scheduling jobs to the cluster it is associated with. The job scheduler manager can utilize slurm schedulers, but can alternatively utilize other schedulers to perform the scheduling and/or management of workloads.

In variants, agents can be configured to generate control instructions and/or system predictions and transmit them to the job scheduling service. In a first variant, an agent can provide high-level control signals to the job scheduling service (e.g., based on the agent's predictions, etc.). Examples of high-level control signals that can be provided can include increase utilization (e.g., cooling capacity is readily available, so more jobs can be dispatched or utilization can be increased), hold in place (e.g., maintain current operational load), slow down (e.g., load profile is outpacing cooling capacity or power capacity), and/or any other high-level control signals. The delay signal can include a high-level control signal (e.g., slow down, pause allocation, etc.), a time duration (e.g., delay job allocations for 5s, 10s, 1 min, etc.), and/or be any other delay signal. The delay signal can be for a single machine, a set of machines (e.g., rack, row, pod, technical loop, region, etc.), all jobs, a subset of jobs (e.g., jobs satisfying a set of conditions, jobs with more than a threshold computing resource requirement, etc.), and/or for any other machine or job set. The high-level control signals can be for one or more timeframes. In an example, the high-level control signals can include a first signal for the next 5 minutes (e.g., slow down), and a second signal for the following 10 minutes (e.g., increase utilization, wherein the cooling and/or power capacity will have been staged and/or ready for use (e.g., energized, in an on-state, etc.) by the following 10 minutes).

In a second variant, an agent can provide operational resource availability predictions (e.g., cooling capacity prediction, power availability predictions, etc.) and optionally operational resource load predictions (e.g., for a given job) to the job scheduling service, wherein the job scheduling service can schedule jobs based on the operational resource availability predictions and/or operational resource load predictions. The operational resource availability predictions can be for each machine, a set of machines (e.g., rack, row, pod, technical loop, etc.), the entire facility, and/or other set of machines. The agent can provide operational resource availability predictions (e.g., cooling capacity prediction, power availability predictions, etc.) and optionally operational resource load predictions (e.g., for a given job) to the job scheduling service, wherein the job scheduling service can schedule jobs based on the operational resource availability predictions and/or operational resource load predictions. For example, jobs predicted to have large thermal loads can be deprioritized (e.g., if there are not enough cooling resources available, etc.). In variants, a prioritization order of the jobs can be determined based on the predictions (e.g., heat load, power load, etc.) and/or a state of the facility (e.g., available resources, local temperatures, etc.). Jobs can be executed according to this prioritization order. In another example, jobs predicted to have high thermal loads can be scheduled to machines anticipated to have higher cooling capacity.

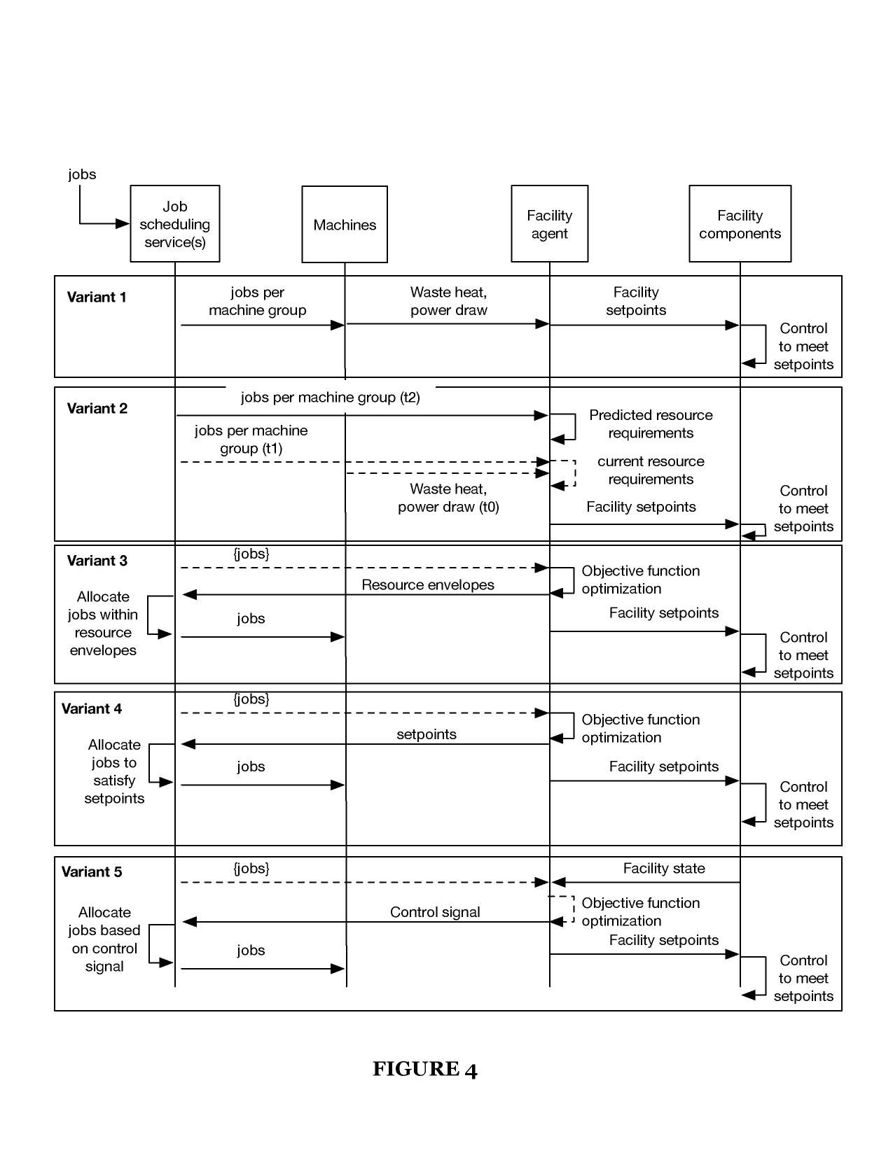

The job scheduling service can schedule workloads using one or more methods. In a first variant, the job scheduling service can schedule workloads using conventional methods and inputs (e.g., example shown in FIG. 4 under variant 1). The job scheduling service can additionally and/or alternatively use any other suitable scheduling methods and/or inputs.

In a second variant, the job scheduling service schedules workloads based on the control signals (e.g., received from the facility agent) (e.g., example shown in FIG. 4 under variant 5). The job scheduling service can schedule more workloads to the machines when the control signal greenlights more job allocation, and/or any other suitable scheduling adjustments. In an example of the second variant, the job scheduling service sheds jobs when thermal or power limits are reached or predicted to be reached or exceeded.

In a third variant, the job scheduling service can schedule workloads based on current or future resource capacity (e.g., example shown in FIG. 4 under variant 3), wherein current or future resource capacity is received from the facility agent, predicted by the job scheduling service (e.g., based on facility setpoints sent to the job scheduling service, the facility infrastructure state, etc.), or other facility control system, and is treated as a constraint when determining workload allocation. The job scheduling service can optionally receive (e.g., from an approximator, from an agent, etc.) or predict the anticipated resource consumption for each job, wherein the anticipated job resource consumption is used when determining the workload allocation. The job scheduling service can alternatively receive or predict the computational power needs and thermal loads for potential job placements across different hierarchical levels (e.g., rack, pod, cluster, etc.). In an example of the third variant, these predictions feed into the scheduler's optimization algorithm as constraints, which then outputs optimal job placement decisions that minimize total facility operating costs while maintaining performance requirements. In a first example, the job scheduling service can preferentially allocate jobs to machines with lower cooling demands or those in areas with better energy efficiency, but can additionally and/or alternatively be otherwise configured for job allocation. In a second example, the job scheduling service can preferentially allocate jobs (e.g., higher volume of jobs, higher priority jobs, etc.) to machines in cooler areas of the data center, but can additionally and/or alternatively be otherwise allocated. In a third example, the system monitors actual resource utilization patterns, proactively increases job allocation when the jobs are not fully saturating their allocated resources, and proactively manages load shedding of lower priority jobs when needed to maintain operation within physical constraints (e.g., determined based on the current facility setpoints, predicted by the facility agent, etc.). This predictive capability can enable data centers to oversubscribe power and cooling infrastructure while ensuring high-value workloads are protected through intelligent job placement and priority-based load management across multiple hierarchical control levels.

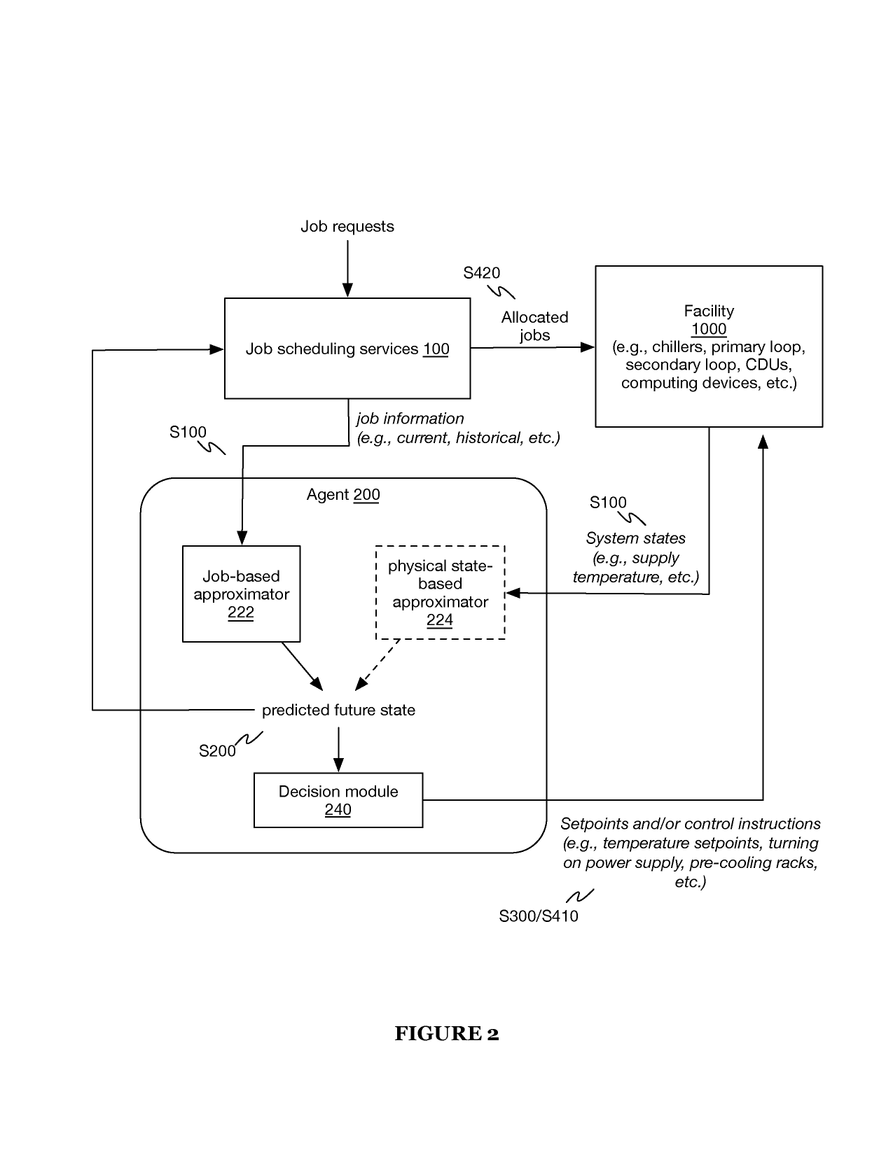

In a fourth variant, the job scheduling service schedules workloads based on IT setpoints provided by the facility agent (e.g., example shown in FIG. 2 under variant 4), wherein the job scheduling service allocates workloads to satisfy the IT setpoints (e.g., number of machines, etc.). The job scheduling data can be provided to the set of agents using one or more methods. In a first variant, the job scheduling services can transmit a notification and/or message when jobs are received, scheduled, allocated, running, completed, failed, and/or any other status. The job scheduling data can be published on a stream, pushed to the agents and/or agent endpoint, and/or otherwise provided. In a second variant, the system periodically polls the job scheduling service (e.g., the base command manager API, etc.) to retrieve status updates. In a third variant, the job scheduling data can be provided to the set of agents wherein the system installs scripts that sit alongside the job scheduling service and/or the nodes (e.g., prolog and epilog scripts), and push job scheduling data or notifications to the system upon job allocation and/or termination, wherein the system can optionally pull additional information from the job scheduling service (e.g., the BCM) upon receipt of the notifications (e.g., for the identified jobs, nodes, etc.). This can reduce the load on the BCM. The prolog script can be executed after the job is allocated but before it runs, and/or at any other time. The epilog script can be executed on the same node where the job scheduling service role is assigned, such as upon job termination. In an example, the epilog script can push the $SLURM_JOB_ID to signal the system to gather final job statistics from BCM.

However, the set of job scheduling services 100 may be otherwise configured.

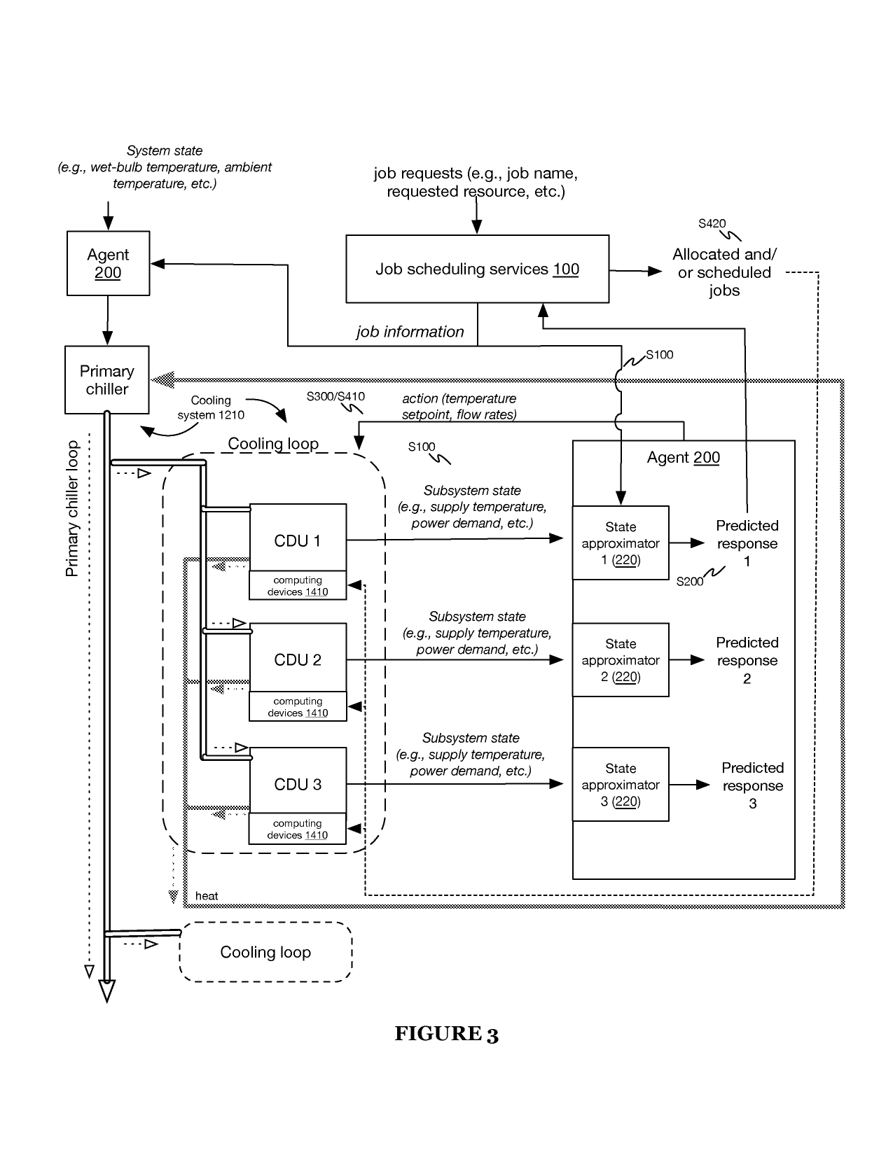

The set of agents 200 can function as a supervisory controller for the facility infrastructure. In variants, the set of agents 200 can determine control instructions, setpoints, and/or predictions for the facility. In variants, the set of agents 200 can be in communication with the facility control systems and/or controllers in order to actuate the determined setpoints and/or instructions. The set of agents can include local agents (e.g., for controlling individual CDUs and/or subsystems of the facility), facility agents (e.g., for controlling facility-wide systems, etc.), and/or any other agents, as shown for example in FIG. 3. In variants, each agent can include an approximator 220 (e.g., a predictive model, a dynamic model), a decision model 240 (e.g., an action model, etc.) and/or any other suitable components. In variants, the agents can have a set of learned policies and/or rules. The policies can be learned through policy gradient, proximal policy optimization, and/or any other algorithm. The agents can be learned from historical resource consumption, historical power draw-thermal load pairs, job parameter-resource consumption pairs, and/or any other suitable historical data pairs. The agents can be learned using reinforcement learning, supervised learning, and/or any other suitable learning methods. In an example, the agent (e.g., decision model, approximator, etc.) can be learned by controlling the facility based on the setpoints, determining the facility response (e.g., from the facility state, from the IT infrastructure state, etc.), generating a reward based on the facility response (e.g., a reward and/or penalty based on a deviation in an expected temperature after determining a facility action and/or setpoint and the measured temperature, a reward and/or penalty based on a computing devices temperature and an operation temperature limit, etc.), and learning off the setpoint-reward pair. In a specific example, an approximator of the agent (e.g., for predicting heat load, etc.) can be trained using historical system state and/or job data with a measured heat load as the training target. The agent coefficients, weights, and/or parameters can be tuned using gradient descent, evolutionary algorithms, Bayesian optimization, stochastic search, and/or any other suitable optimization technique or search process.. However, the agent can be trained in any other suitable method. In variants, the agents can be trained offline or online. In variants, it can be beneficial if the agents are trained, modified, and/or tuned online, which can allow the agents to continuously be updated. This can ensure that the agents continue to be accurate as the facility is modified or evolves (e.g., through degradation of components, etc.).

The set of agents 200 can include a single facility agent, but can alternatively include different facility agents for different facility infrastructure subsystems or instances thereof. The set of agents 200 can include multiple local agents (e.g., one for each set of machines, one for each technical loop or secondary loop, one for each CDU, etc. etc.), but can alternatively include a single local agent and/or any other number of local agents. The facility agents preferably runs at a first frequency (e.g., low frequency, every 15 mins, faster than a chiller setpoint frequency limit, etc.), while the local agents run at a second frequency (e.g., high frequency, every minute, etc.). Alternatively, the facility agents can run at a higher frequency and the local agents can run at a lower frequency, or run at any other frequency. In variants, the agents can have a limited frequency. For example, in variants, the facility agent can determine a new setpoint for the industrial facility once every 30 minutes, once every hour, once every two hours, and/or any other frequency (e.g., due to physical and/or operational constraints of the chiller equipment, etc.). However, the set of agents 200 can run at any other suitable frequency. In variants, the agents can determine setpoints and/or make predictions for a time horizon between 5 seconds and a few hours (e.g., 5 seconds, 10 seconds, 20 seconds, 30 seconds, 45 seconds, 1 minute, 2 minutes, 5 minutes, 10 minutes, 20 minutes, 30 minutes, 1 hour, 2 hour, 3 hours, 4 hours, or any value and/or range therebetween). In some variants, the components of the facility can only change setpoint at a limited frequency. For example, a chiller may have a chiller setpoint frequency limit such that the chiller setpoint can only be changed once an hour, once every 30 minutes, once every 20 minutes, or any other suitable frequency.

In variants, the set of agents 200 can be used to control thermal systems (e.g., chillers, CDUs, cooling loops, etc.), power systems (e.g., power supply, generator, etc.), and/or any other systems. In variants, the facility agent can control industrial system-scaled components such as HVAC systems, CRAC units, CRAH units, power management, and/or any other suitable component. In variants, the system can include a plurality of local agents. For example, the system can include a local agent for every CDU, every rack, every machine, every zone, and/or any other set or subset of facility components.

In variants, the agents can be used to inform (e.g., control, affect, modify, alter, etc.) the operation of the job scheduling services. In variants, the agents can be used to inform (e.g., control, affect, modify, alter, etc.) the operation of the job scheduling services. For example, in variants, the output (e.g., setpoints, predictions, etc.) of the agents can be passed to the job scheduling services. The agent output can be used to modify the prioritization of jobs (e.g., delay jobs, rush a job, re-direct a job, modify allocated resources of a job, etc.).

The agents can include: a regression-based neural network trained on historical operational data, a dynamic model (e.g., physics model, numerical solver, etc.), a regression, a neural network (e.g., DNN, GNN, etc.) that directly predicts outputs (e.g., setpoints), and/or any other suitable components. The agents can receive as input sensor data (e.g., temperature, return temperatures, supply temperatures, ambient temperature, differential pressure, humidity, flow rate, power measurements, current, voltage, uninterruptible power supply measurements, remote power panel power measurements, etc.), environmental temperature (e.g., season, outdoor temperature, wet bulb forecasts, weather predictions, etc.), computing device information, information technology data (e.g., job scheduling data, etc.), historical data, external factors (e.g., wet bulb temperatures), and/or any other input. Examples of computing device information can include temperature limits (e.g., T-limits), throttling limits, machine utilization, memory usage, network bandwidth, power draw, response times, error rates, and/or any other computing device information. In other variants, the agents can receive as input information technology information from the job scheduling services. Examples of information technology data that can be received from the job scheduling services can include job identification, job name, allocated CPUs and/or GPUs, allocated nodes, allocated trackable resources, number of requested CPUs and/or GPUs, number of requested nodes, submission time, job start time, job end time, it code, number of prior runs, job history and/or any other information technology data. In other variants, the agent (e.g., facility agent, local agent, etc.) can receive as input historical data. For example, the agent can receive thermal and/or power logs of previous jobs, prior runs of the jobs (e.g., prior runs of job currently queued, etc.), success and/or failure information of historical jobs, and/or any other historical information.

In variants, the agent (e.g., facility agent, local agent, etc.) can monitor for submitted jobs that are computationally intensive (e.g., large amount of requested resources). In variants, when computationally intensive jobs are determined, data associated with job, such as historically runs, resource utilization, run time, used resource, failure history, and/or any other data can be requested, received, or recovered. In variants, this job data can be used for predicting system state and/or determining setpoints. In a first variant, the job data can be encoded for further use with the agents (e.g., one-hot encoding, label encoding, ordinal encoding, binary encoding, frequency encoding, etc.).

In some variants, the agent (e.g., facility agent, local agent, etc.) can predict a future state (e.g., thermal load, power load, etc.) based on the system state and/or the job information (e.g., using an approximator 220). Specifically, the agent can make a state-based prediction, a job-based prediction, a hybrid prediction, and/or an aggregated prediction. For example, the state data and job data can be passed together through a model (e.g., early fusion) to determine a prediction or set of setpoints. In another example, a state-based prediction and a job-based prediction can be determined (e.g., using separate model, etc.) and the predictions can be aggregated (e.g., late fusion). Aggregating the predictions can include averaging, weighted averaging, summation, normalizing, and/or any other suitable steps. However, a hybrid and/or aggregated prediction can be otherwise determined. In other variants, only a state-based prediction and/or job-based prediction can be determined, utilized (e.g., for setpoint determination), and/or otherwise used.

In variants, the set of agents 200 can make job-level (e.g., job-specific) predictions, component-level predictions, machine-level predictions, rack-level predictions, and/or any suitable predictions. In variants, the predictions can be job-level (e.g., job-specific) predictions, component-level predictions, machine-level predictions, rack-level predictions, and/or any suitable predictions. For example, a prediction (e.g., thermal load, power load, etc.) can be made for each job. In variants in which multiple predictions are determined (e.g., for each job, each machine, etc.), the set of agents 200 can aggregate the predictions to determine a total power consumption. In a first variant, the predictions (e.g., heat load, power load, etc.) can be aggregated based on time and summed in order to determine a total load at a specific time. In a second variant, the predictions (e.g., heat load, power load, etc.) can be aggregated based on location (e.g., within the facility, rack location, computing device location, etc.) and summed in order to determine a total load in a specific zone, aisle, and/or rack of the facility. Aggregating based on location can create a heat map of the facility that describes where heat can be accumulating within the facility.

The agent (e.g., decision model 240, etc.) preferably determines facility setpoints for the facility infrastructure, but can alternatively determine high level control signals (e.g., proceed, hold, halt, shed, etc.), IT setpoints, IT constraints, low-level control instructions, and/or other control instructions. The set of agents 200 can determine facility setpoints that cause facility infrastructure to provide physical resources (e.g., cooling capacity, power capacity, etc.) to the IT infrastructure. For example, the facility setpoints can include turning on and off power generators and/or supply such as turbines, piston engines, batteries, and/or any other power source. In an example, the facility agent (e.g., decision model, etc.) can determine chiller setpoints (e.g., on-off state, differential pump pressure, temperature, flow rates, etc.), air cooling setpoints (e.g., fan speed, etc.), CDU setpoints (e.g., flow rates), cooling loop setpoints (e.g., supply temperature, return temperature, etc.) and/or any other setpoints. The facility setpoints can cause the facility infrastructure to output sufficient physical resources for current IT demands (e.g., current workloads), proactively adjust resource availability based on predicted loads (e.g., from upcoming workloads, power demand data, etc.), and/or otherwise control the facility infrastructure. The facility setpoints are preferably provided to the facility control systems (e.g., wherein the facility control systems control the facility components to meet the facility setpoints), but can alternatively be provided to the set of job scheduling services, not be provided to any endpoint, and/or otherwise managed.

The set of agents 200 can determine facility setpoints based on the facility infrastructure state (e.g., from the facility infrastructure subsystems, etc.), weather, explicit job workload information (e.g., IT workload information, job scheduling information, etc.; provided by the job scheduling services, received from the data network, etc.), IT state information (e.g., machine resource demand, machine temperatures, machine power draw, etc.), other leading indicators, and/or other factors. In variants, the facility setpoints can be determined based on leading indicators (e.g., power draw, workload information, etc.), wherein the facility agent can predict the future thermal demand based on the leading indicators, and set the setpoints based on the predictions. In examples, the facility state can include pump rate, flow rate, valve positions, ingress temperature, egress temperature, supply temperature, return temperature, ambient temperature, computing device temperature, on-off state (e.g., of chillers, of power generators, etc.), and/or any other suitable state parameters. In examples, the IT workload information can include network traffic, job queue depth, job type (e.g., inference, training, etc.), job size, job payment rate (e.g., monetary return), job priority, other job parameters, and/or any other suitable information. The IT workload information can be associated with historical runtime characteristics (e.g., thermal characteristics, power characteristics, etc.). In examples, the IT state information can include the thermal load profile, derivatives thereof (e.g., pace, etc.), machine metrics (e.g., machine utilization, memory usage, network bandwidth, power draw, etc.), application performance metrics (e.g., response times, error rates, throughput, etc.), and/or any other suitable information. The facility setpoints can alternatively not be determined based on explicit job workload information, wherein the facility agent responds to the physical effects of assigned job workloads.

In variants, the agent (e.g., decision model 240) can determine the setpoints by optimizing an objective function, but can alternatively determine the setpoints by predicting the setpoints directly (e.g., using a classifier, etc.), using policies and/or heuristics, and/or any other suitable determination method. In an example, the facility agent can measure and/or estimate an internal state, roll out the power, thermal, or other physical trajectories over the internal state (e.g., using dynamic modeling, an approximator, etc.), and determine a set of setpoints that optimize a target variable (e.g., power) over that trajectory. The objective function can include power, cost, job metric, and/or any other suitable target parameter, as a function of the facility state inputs, optionally workload state inputs, and setpoint values.. In examples, the objective function can model the amount of power consumed by the facility infrastructure, the amount of power consumed by the IT infrastructure, and/or other power. The objective function can be learned based on historical operation data (e.g., including resource consumption, resource capacity, facility state, IT infrastructure state, setpoints, facility responses, etc.), manually specified, or alternatively otherwise learned. The objective function for the set of agents 200 can be alternatively otherwise defined. The set of agents 200 optimization preferably iteratively searches for the setpoint value permutation that optimizes the target variable value (e.g., minimizes the power consumption or operational cost) while satisfying a set of constraints, but can alternatively predict the setpoint value permutations, and/or any other suitable setpoint determination method. In examples, the target variable value can be determined by estimating an internal state based on the setpoint value permutation and rolling out the power, thermal, or other physical trajectory over the internal state, or can alternatively otherwise be determined. The setpoint value permutation can be identified using various methods. The setpoint value permutation can be identified using branch & bound, simulated annealing, genetic algorithms, greedy algorithms, and/or any other suitable identification method. The constraints for the set of agents 200 are preferably set by the facility operator, but can alternatively be set based on the predicted resource demand from IT workloads (e.g., determined from job scheduling information), be learned, and/or otherwise determined.

In an example, power demand, job scheduling information, and/or other leading indicators are used to predict the future thermal demand, wherein the future thermal demand is used as a minimum constraint on the optimization. In a specific example, facility setpoint values can be determined by dynamically modeling the thermal response and integrating the thermal load over time to determine minimum cooling capacity requirements. The setpoint values can be determined by constraint-based optimization where power usage data and job scheduling information provide bounds on required cooling capacity, which then constrain the allowable setpoint ranges. However, the setpoint values can alternatively be otherwise determined.

In a specific variant, the set of agents 200 can determine setpoints for a primary chiller loop by minimizing a number of chiller used (e.g., current, future, etc.) and/or maximizing a chiller temperature (e.g., current, future, etc.) required to handle a predicted heat load (e.g., determined from the approximator, etc.). This optimization can have the benefit of minimizing power consumption during operation of the industrial facility. In another variant, the setpoints can be determined based on policy learned through reinforcement learning. In an example, the agent can receive as input a set of system states, job information, and/or any other suitable data. The agent determines a future state (e.g., thermal and/or power load) based on the input (e.g., using the approximator, predictive model, etc.). Based on this future state, setpoints are determined using a set of learned policies (e.g., using the decision model). However, the setpoint values can be otherwise determined. When the facility agent receives IT information, the facility agent can be reactive to IT workloads (e.g., dynamically determine setpoints that scale facility resources up and down based on the current or anticipated IT workloads), predictively control IT workload allocation (e.g., by setting resource envelope constraints, by directly allocating jobs, by identifying which jobs to shed, etc.), and/or otherwise interact with IT information. When the facility agent controls subsets of computing devices, the facility agent can include various components or functionalities. When the facility agent controls subsets of computing devices, the facility agent can include different objective functions for each machine subset (machine group), different setpoints for each machine subset, different input state variable sets for each machine subset, and/or any other suitable machine subset control parameters.

In some variants, the agents and/or job scheduler can configure policies, rules, and/or heuristics that constrain how the jobs are allocated. In variants, these policies can ensure that a power draw and/or load of the facility maintains certain power compliance ranges (e.g., the jobs are allocated to stay within allocated power envelopes). For example, the agents and/or job scheduler can schedule jobs (e.g., based on predicted power loads, etc.) such that power load is distributed temporally to ensure that the facility maintains power compliance ranges (e.g., to maintain an ideal power draw at any time, to ensure a power draw is below threshold limit at any time, etc.). In other variants, jobs associated with high power loads may be delayed and/or scheduled such that the power draw of the facility does not exceed a power draw threshold at any time.

In a first variant, the facility agent can react to current resource demands. The facility agent can receive power demand from the machines (e.g., indicative of imminent computation), predict the future thermal load based on the current power demand (e.g., using a model learned based on historical data, using a lookup table, using the approximator, etc.), and dynamically scale up thermal capacity (e.g., by adjusting the facility setpoints) to accommodate the future thermal load. An example of this variant is shown in FIG. 4 under variant 1.

In a second variant, the facility agent of the set of agents 200 can react to predicted resource demands. The facility agent can receive job allocation information (e.g., from the job scheduling services), predict future resource demands (e.g., power and thermal demands) based on the job information (e.g., using the approximator), and use the predicted power and thermal demands as minimum constraints on the facility setpoint optimization. The future resource demands can be for the entire set of computing devices or a subset thereof (e.g., a specific data center, data hall, zone, pod, row, rack, machine, etc.). When the future resource demands are on a machine subset level, the overall objective function can be formed from objective subfunctions, each specific to the machine subset, but can alternatively be otherwise constructed. In an example of the second variant, the facility agent can react to predicted resource demands. This variant can include ingesting facility data (power costs, cooling availability, weather forecasts) and job characteristics (type, priority, size) as inputs. The system can predict both computational power needs and thermal loads for potential job placements across different hierarchical levels (rack, pod, cluster). These predictions can feed into the scheduler's optimization algorithm as constraints, which can then output optimal job placement decisions that can minimize total facility operating costs while maintaining performance requirements. An example of this variant is shown in FIG. 4 under variant 2.

In a third variant, the facility agent of the set of agents 200 determines job allocation constraints. In this variant, the facility agent can optionally receive workload information (e.g., future workload, unassigned workload, etc.) from the set of job scheduling services, determine resource envelopes for the IT infrastructure as a set of IT constraints, and/or pass the resource envelopes as constraints to the IT infrastructure (e.g., the job scheduling services), wherein the set of job scheduling services treat the resource envelopes as constraints, and manages the workloads to maintain the resource consumption within the resource envelopes. An example of this variant is shown in FIG. 4 under variant 3. The job scheduling optimization can use a reward mechanism for scheduling. The job scheduling optimization can use a reward mechanism for scheduling more jobs, jobs of a certain type (e.g., training over inference jobs, etc.), jobs of a certain return (e.g., payment), and/or any other suitable jobs. This can prevent the facility agent from scheduling no jobs. The job scheduling optimization can alternatively be constrained by a minimum job constraint (e.g., minimum number of jobs, minimum amount of money earned, etc.), or otherwise constrained. The resource envelopes can be for the entire computing device set or a subset thereof. In variants where the resource envelopes are for a subset, a different IT setpoint is represented in the objective function for each resource-computing device subset pair, but can alternatively be otherwise represented. The IT constraints can be soft (e.g., overcooling, temporarily allowing overheating, etc.) or hard.

In a fourth variant, the facility agent of the set of agents 200 determines machine allocation setpoints. In this variant, the facility agent can receive IT state information (e.g., machine resource demand, loading rate, load profile, etc.) and optionally job allocation information (e.g., from the job scheduling services), determine the IT setpoints, and/or pass the IT setpoints to the set of job scheduling services, wherein the set of job scheduling services assigns the workloads to satisfy the setpoints. The IT setpoints can include the number of machines (e.g., to schedule, to allocate to a power domain, etc.), clock speed, and/or any other suitable setpoints. The resource envelope can be the currently available envelope, a future envelope (e.g., determined based on the optimized facility setpoints, etc.), and/or resource envelope for another timeframe. In variants, this can allow the number of machines allocated to a power domain to be higher than what the rated thermal design power (TDP) would typically allow (e.g., since the facility agent is allocating GPUs based on actual and predicted consumption, instead of a set maximum assumed thermal load). An example of this variant is shown in FIG. 4 under variant 4.

In a fifth variant, the facility agent of the set of agents 200 can function as a remote load balancer controller. In this variant, the facility agent can receive IT state information (e.g., current machine resource demand) and optionally job allocation information (e.g., from the job scheduling services), determine whether the future resource demand will exceed the future resource availability, generate a control signal based on the analysis (e.g., according to a set of rules, a predicted control signal, predicts a control signal class, etc.), and/or provide the control signal to the load balancer, wherein the load balancer allocates jobs based on the control signal. In examples of the fifth variant, control signals can include various types of signals used by the facility agent in its role as a remote load balancer controller. Examples of control signals can include: proceed (e.g., more jobs can be assigned), slow (e.g., slow the rate of new job assignment, etc.), hold (e.g., maintain the number of assigned jobs), retreat (e.g., shed jobs in progress), and/or any other suitable control signals. The facility agent can operate at a higher frequency than facility setpoint determination (e.g., in real- or near-real time), at the job scheduling frequency, and/or at any other suitable frequency. An example of this variant is shown in FIG. 4 under variant 5.

The set of agents 200 can include an approximator 220 and a decision model 240. The approximator 220 functions to predict or calculate a physical property value given a set of states, setpoint values, job data, and/or any other data. The approximator (e.g., predictor) can predict thermal load (e.g., heat load), future temperatures, power load, a power and/or thermal load differential and/or residuals (e.g., an increased thermal load associated with a specific component, delta residual, subtraction residual, etc.), and/or any other predictions. The approximator can make the prediction based on system states (e.g., supply temperate, return temperature, computing device temperature, etc.), job information (e.g., number of new jobs, number of jobs estimated to be completed during the future timeframe, number of requested resources, allocated resources, etc.), weather (e.g., temperature, etc.), and/or time (e.g., time of day, time of year, season, etc.). In variants, weather and time (e.g., time of day, time of year, season) can affect the temperature and cooling of the facility. For example, a hotter day may be associated with higher thermal loads. In variants, the approximator can make a state-based prediction, a job-based prediction, a hybrid prediction, an aggregated prediction, and/or any other suitable prediction. In variants, the prediction can be for a single job, a job type, a cluster, a rack, a region and/or zone of the facility, a set of jobs (e.g., a set of queued jobs), a future time, and/or any other type of prediction. In variants, the prediction can be for a single job, a job type, a cluster, a rack, a region and/or zone of the facility, a set of jobs (e.g., a set of queued jobs), a future time, and/or any other type of prediction. For example, the agent can make a heat load prediction for a single job. In another example, the agent can make a heat load prediction for a rack or region within the industrial facility (e.g., a region within the facility will experience a significant increase in heat load, etc.).

In variants, the approximator can be a trained and/or learned machine learning model (e.g., neural network, recurrent neural network, deep autoregressive models, etc.), a statistical model (e.g., regression model, etc.), a physics-based model, a simulator (e.g., physics-based simulators, etc.), time-series models, and/or any other suitable model. The approximator can be trained, learned using reinforcement learning, handcrafted, and/or otherwise developed. In variants, approximator can compute a predicted state for a predetermined time point, a forecast of predicted states, confidence intervals for different predicted states, and/or any other suitable model. In a specific variant, the approximator is a model that represents time-dependent responses (e.g. temperature and/or power consumption) as triangular waveforms, parameterized by slopes, temporal parameters, and/or magnitudes (e.g., triangle model)In these variants, the triangle waveforms can represent accumulation and dissipation of heat and/or increases and decreases in power consumption. In variants, the integral of the triangle can represent a total expected heat load. In a specific example, the triangle model can predict the resource load (e.g., thermal load) based on the power demand from a machine or set thereof. These models can be used to predict the resource load for a single machine or machine group, but can additionally or alternatively be used to predict the resource load for overall industrial system (e.g., multiple machines, multiple machine groups, etc.).

In variants, the approximator can include a neural time-series model (e.g., neural prophet, LSTM, N-BEATS, TCNs, neural generalized additive models, etc.). These models can model a timeseries (e.g., the physical phenomena) as a time series (e.g., based on the trend, seasonality, events, past values, and a neural residual). In variants, the model can include a hybrid architecture of deterministic learned parameters (e.g., trend, seasonality, events, etc.), autoregressive components (e.g., using an AR-net, a regression, etc.), and a neural network (e.g., a feed forward network that captures nonlinear patterns).

In a specific example, the approximator can predict a resource load (e.g., thermal load, power load, etc.) for a future timestep based on: past resource load values, external factors (e.g., used as a future regressor), and job scheduling data (e.g., used as a future regressor). The job scheduling data that is used can include: number of resources requested (e.g., requested GPUs/CPUs), job type, historical run information (e.g., average utilization, run duration, recent failure trends), and/or other data. These models can be used to predict the resource load for the overall industrial system (e.g., multiple machines, multiple machine groups, etc.), but can alternatively be used to predict the resource load for a single machine or machine group. In variants, the approximator can include a neural network (e.g., GNN, CNN, DNN, RNN, transformer, etc.) trained to predict the resource load given the current industrial system state (e.g., current cooling capacity, power capacity, cooling demand, power demand, etc.) and job scheduling data.

In variants, the control system can include a plurality of approximators. For example, in a specific variant, the agent can include a job-based approximator 222 and/or predictor, which can predict a future system state (e.g., heat load, etc.) based on job information, and a physical state approximator 224 and/or predictor, which can predict a system state (e.g., heat load, etc.) based on current heat and/or power draw measurements. In variants, these two future system states can be combined (e.g., aggregated, summed, averaged, weight-averaged, and/or any other combination) to determine a combined future state.

In some variants, the plurality of approximators can be sequential, hierarchical, or otherwise organized. For example, the approximators can be organized such that the output of one approximator serves as the input of another. In a specific variant, the control system can include a power load predictor, which predicts power load based on job data, and a heat load predictor, which predicts heat loads based on the predicted power load. The agent can include any set or hierarchy of approximators.

In variants, the control system can optionally predict confidence intervals for each prediction. The confidence interval is preferably determined by the respective approximator, but can additionally or alternatively be determined by another model (e.g., another neural network), and/or otherwise determined. The confidence intervals can be used to select which predictions to use (e.g., wherein predictions with more than a threshold confidence interval are selected for use), and/or otherwise used. The confidence interval threshold can be selected to increase optimality (e.g., less wasted energy), provide greater safety buffers (e.g., by reserving more capacity), and/or be otherwise selected. The confidence interval thresholds can be manually determined, automatically determined (e.g., based on the job scheduling data, based on the volume of scheduled jobs, based on the volume of incoming jobs, etc.), and/or otherwise determined.

However, the approximator 220 may be otherwise configured.

The decision model 240 functions to determine setpoints, policies, and/or job-scheduling and/or allocation decisions based on the predictions of the approximator. In some variants, the decision model can determine time (e.g., execution times, etc.) for each setpoint (e.g., based on temporal limits of system components, etc.) In a first variant, the decision model 240 can include a statistical model and/or predictive model that uses the predictions as input and/or variables for computing setpoint. For example, the decision model can include a multilayer perceptron model, physics-based model, regression model, machine learning model, and/or any suitable model that can perform computations based on the predictions made by the approximators and/or predictors. The decision model can be trained, learned using reinforcement learning, and/or otherwise determined. In a second variant, the decision model 240 can utilize a set of policies, rules, and/or heuristics to determine setpoints based on the predictions. In a third variant, the decision model 240 can be a look-up table relating setpoints with system state and/or predicted load (e.g., thermal load, power loads, etc.).

In variants in which the decision model determines job scheduling and/or job allocation decisions, the scheduling and/or allocations can be based on a set of rules, heuristics, policies, and/or other models. In variants, these policies can be learned (e.g., through reinforcement learning, etc.), manually determined, and/or otherwise determined. In variants, the policies can be learned based on the facilities ability to maintain predetermined power draw constraints and/or bounds. For example, a reinforcement learning reward mechanism can ensure that policies that prevent the system from exceeding power compliance ranges or policies that maintain an ideal power draw are learned.

In a first example, the facility agent can include a facility agent decision model. The facility agent decision model can determine the setpoints for the facility infrastructure (e.g., primary loop, power generators, etc.), wherein the setpoints are sent to the BMS for implementation (e.g., to proactively turn facility resources on or off). The setpoints can include the number of chillers to stage in the next timestep, the number of power sources (e.g., power generators) to stage in the next timestep, the average LCHWT setpoints (Leaving Chilled Water Temperature setpoints), and/or any other setpoints. The facility agent decision model can determine the setpoints using an optimization, a prediction, a ruleset, and/or otherwise determine the setpoints. The optimization objectives can include: minimizing the number of running chillers, minimizing running power generators, maximizing the average LCHWT setpoints, and/or any other optimization objectives. The optimization can be performed based on a set of constraints. The set of constraints can include a minimum required number of chillers and/or power generators (e.g., determined from the predicted resource load received from the approximator), Rate of Change (RoC) for Leaving Chilled Water Temperature (LCHWT), chiller staging limits (e.g., minimum time a chiller should be off), a decoupler flow limit (e.g., 0, positive, not negative, etc.), and/or any other constraints. The inputs to the facility agent decision model can include real-time industrial system data (e.g., BMS data), historical plant sensor data, wet bulb forecasts, the set of constraints (e.g., including or derived from the leading signal indicator provided by the job workload data), and/or other data.

The facility decision model can be learned using reinforcement learning (e.g., wherein the reward signal can be maximized plant performance, whether the LCHWT values are maximized, whether the chiller and/or power generator count are minimized, etc.), training on historical data, and/or otherwise developed. In a second example, the local agent can include a local agent decision model. The local agent decision model can determine the setpoints for the local control regime (e.g., the technical loop, the secondary loop, the set of controlled CDUs, etc.), wherein the setpoints are sent to the respective CDUs for implementation. The setpoints can include the secondary supply temperature setpoint of CDU and/or other setpoints. The local agent can determine the setpoints using an optimization, prediction, ruleset, computation, and/or other method.

The inputs to the local agent can include instantaneous power consumption, power demand, job workload information for the nodes/machines within the local control regime (e.g., functioning as leading signal indicator to provide advanced lead time compared to instantaneous power readings, allowing the local agent to pre-cool the loop proactively), and/or any other inputs. The job workload information for the nodes within the local control regime can be determined based on overall node availability (e.g., wherein available nodes have a higher probability of being assigned jobs) for the current timestep and/or the future timestep, by explicitly receiving the job-to-node assignments from the job scheduler (e.g., from a node list), and/or any other determination method.

However, the decision model 240 can be otherwise configured.

The agent can have a set of operation modes. Examples of operation modes can include a normal operating mode, a safe mode, a reduced-functionality mode, a fallback mode, a fault-responsive mode, and/or any other suitable modes. The operation mode can be selected manually, automatically, in-response to a trigger (e.g., anomaly detection, operational error detection, sensor measurement exceeding a threshold, etc.), and/or in any suitable manner. In variants, the agent can operate in a fault-responsive mode when abnormal behavior is determined. Examples of abnormal behavior can include: data and/or information ceasing to send, data and/or information degrading, temperatures (e.g., secondary supply temperatures, primary supply temperatures, return temperatures, etc.) rising beyond an acceptable margin, mechanical issues (e.g., pump failure, valve sticks, etc.), and/or any other abnormal conditions. In variants, depending on these conditions, the agent can dynamically change its behavior to address the changing expected responses. The agent’s operation mode can be determined based on sensor data, system states, predicted system states (e.g., from the approximator, etc.), model outputs and/or encodings, predefined rules and/or heuristics (e.g., mapping the abnormal behavior to a set of default behaviors, mapping abnormal values to a set of default setpoints, etc.), and/or any other suitable information. The operation mode can be independent across agents (e.g., different agents can have different selected operation modes at a time, etc.), systems, subsystems, and/or otherwise controlled. Depending on the operation mode, the agent can alter its operations. Examples of operational modifications can include: selecting and/or utilizing different models (e.g., different approximators and/or decision models, etc.), adjusting model parameters and/or constraints, modifying optimization or control objectives, limiting or disabling certain functions, transitioning from adaptive or data-driven behavior to deterministic and/or rule-based behavior, or any other changes in operation. In some modes, outputs (e.g., setpoints, predictions, etc.) generated by different models and/or agents can be prioritized (e.g., such that a generated setpoint is ignored, replaced, bounded, etc). For example, a safe mode and/or fault-responsive mode can cause the agent to utilize previously determined setpoints, default setpoints, minimum allowed setpoints, setpoints determined from a different control system (e.g., PID), and/or any other setpoint.

In some variants, such as when the primary supply temperature rises beyond a margin or there is an issue with the CDU, the agent can lower the base setpoint below a typical default value. In these and other situations, the CDU may not be able to sufficiently cool the system when on full utilization due to the incident occurring out of scope of the local agent. Running at a lower temperature setpoint can enable the cooling system to cool more aggressively, preventing or limiting impacts of the unfavorable conditions. In other variants, changes in the dynamics of the facility and/or cooling systems can be detected. Examples of changes can include initiation of a large training job, large thermal and/or power draw spikes, a rack in the pod is disconnected, or any other system change. In these variants, the agent’s model can tune its weights to manage the change in dynamics. This mode change could be learned, manually triggered, or deterministically set based on the change in conditions and whether or not our response is less favorable. The possible change in behavior can be broad, including changing the type of model, the type of tuner, the target setpoint, allowed setpoint bands, and/or any other agent parameters.

However, the set of agents 200 may be otherwise configured.

### Method

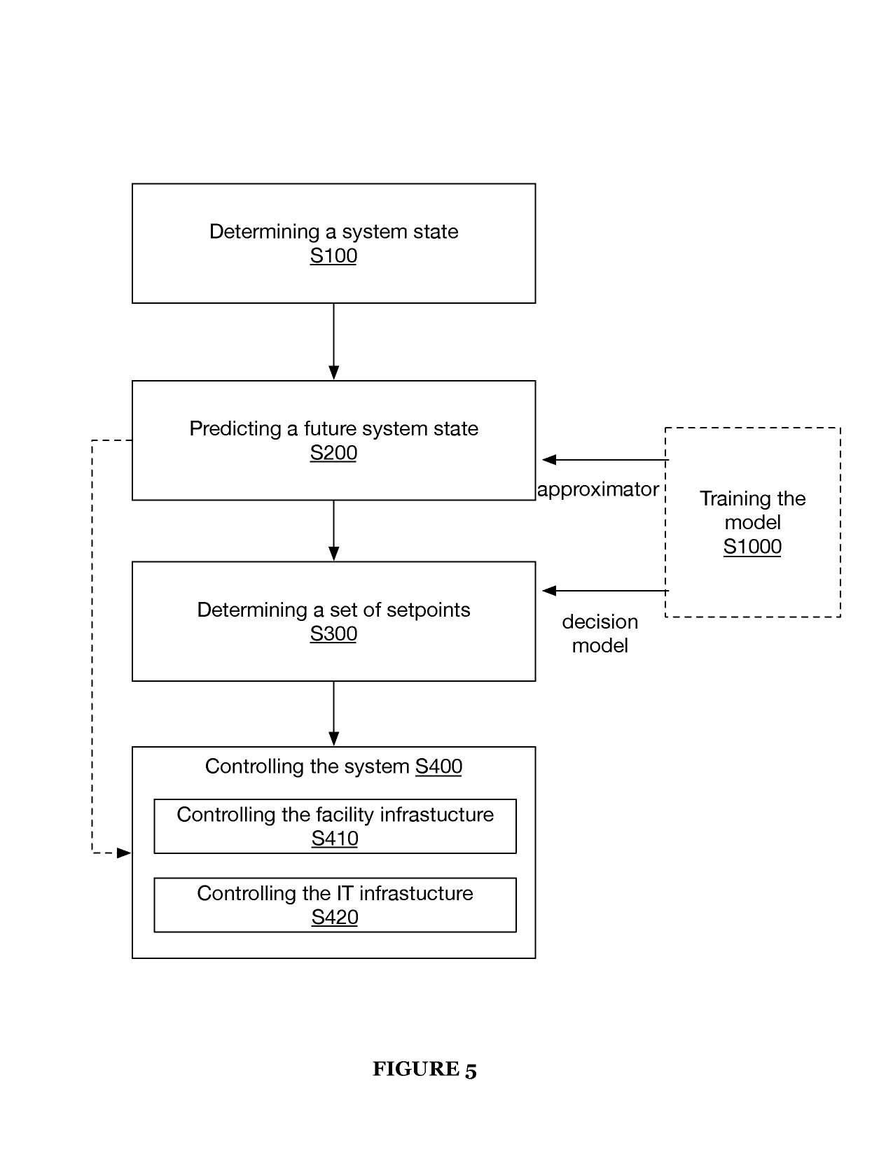

As shown in FIG. 5, the method can include: determining a system state S100; optionally predicting a future system state S200; determining a set of setpoints S300; controlling the system S400; and optionally training the models used by the agents S1000. The method functions to control an industrial system. In variants, the method preferably functions to control the industrial facility previously described. The method can be performed continuously, intermittently, periodically, sporadically, and/or in any suitable manner. The industrial system can be an IT facility, a data center, a regional cluster, a global network, a data hall, a cooling center, a plant, a factory, and/or any other industrial system. In variants, the industrial system can include machines for computing, calculating, chemical processing, machining, reacting, and/or any other suitable function. The method can include variants wherein the industrial system is a data center, and examples of computing devices can include CPUs, GPUs, TPUs, IPUs, microprocessors, servers, and/or any other computing devices. In variants, the industrial system can include an environment conditioning system. The environment conditioning system can include chillers, fluid coolers, cooling distribution units (CDUs), air handlers, power systems, pumps, fans, sensors (e.g., temperature, pressure, flow rate, humidity, etc.), and/or any other component. The system can include job scheduling services. The job scheduling services can distribute the computational workload across the set of computing devices (e.g., by assigning jobs to machines or groups thereof). The job scheduling services can receive jobs, schedule jobs, allocate the jobs, and ensure the jobs run. In examples, jobs that can be supported by (e.g., run by, executed by, etc.) the system can include: web applications, database transactions, machine learning computations (e.g., training, inference, etc.), video streaming, email hosting, file storage operations, virtual desktop infrastructure (VDI), data analytics processing, enterprise resource planning (ERP) systems, high-performance computing (HPC) tasks, and/or any other suitable workloads.

The system can include local control agents, facility agents, and/or any other agents. In variants, the agents can function to determine setpoints based on a system state. In some variants, the agent can additionally and/or alternatively function to predict future system states. However, the agents can alternatively function otherwise. In variants, the agents can include state approximators, predictive models, decision models, control models, and/or any other suitable models. In variants, the agent can receive information from the job scheduling services (e.g., job information, job identification, allocated resources, requested resources, etc.) and determine control instructions and/or setpoints based on the information. In other variants, the job scheduling services can receive predictions (e.g., made by the agents, etc.) and schedule jobs, allocate resources, and/or otherwise function based on the predictions.

In an illustrative example, the method can include determining a system state that includes a set of operation parameters and/or measurements and a set of job information, predicting a thermal load based on the job information and/or operation parameters (e.g., a job-based thermal load, a physical state-based thermal load, job-level heat and/or power loads, aggregated thermal load, etc.), determining a set of setpoints based on the thermal load using a set of learned policies (e.g., reinforcement learning model), and controlling the system. Controlling the system can include controlling facility infrastructure based on the setpoints and/or predictions (e.g., turning on power supplies, controlling valves, pumps, and/or chillers, etc.) and controlling job allocation based on the predictions (e.g., de-prioritizing jobs, delaying jobs, rushing job, etc.).

Determining a system state S100 functions to determine a set of values and/or parameters that describe the system. The system state can describe system operation parameters, physical properties, computational load, power consumption, and/or any other characteristics. S100 can be performed continuously, periodically, intermittently, sporadically, and/or at any other frequency. S100 can include measuring values using sensors (e.g., temperature sensors, pressure sensors, flow sensors, etc.). The examples of sensor measurements can include temperature (e.g., ambient temperature, supply temperature, return temperature, ingress temperature, egress temperature, computing device temperature, etc.), pressure, flow rates, humidity, and/or any other sensor measurement. In variants, S100 can include determining system setpoints as part of the system state. The setpoints can include chiller temperature setpoints, fan speed, valve position, flow rate setpoints, pressure setpoints, and/or any other setpoints. In variants, the system state can include workload (e.g., scheduled workload, queued workload, current workload, anticipated workload, etc.). In variants, the system state can include workload (e.g., scheduled workload, queued workload, current workload, anticipated workload, etc.). For example, the system state can include a state of the job scheduling services. The workload can be associated with job identification, requested resources (e.g., CPUs, GPUs), allocated resources, job submission time, start time, and/or any other association. System states (e.g., sensor measurements, setpoints, workload, etc.) can be stored (e.g., to create a time series of system states, etc.) or can be updated and/or replaced. However, determining a system state S100 may be otherwise performed.

The method can optionally include predicting a future system state S200, which functions to determine future system parameters and/or values based on the system state. S200 can be performed by a state approximator, a predictive model, and/or any type of model. The state approximator can include a machine learning model (e.g., neural network, multilayer perceptron model, convolutional neural network, recurrent neural network, etc.), a physics-based model, a statistical model (e.g., linear regression, logistic regression, Poisson regression, time series model, etc.), a probabilistic model, a hybrid model, and/or any other model. The state approximator can be trained and/or learned to determine (e.g., predict, estimate, compute, etc.) a future system state. The future system state can be computed, calculated, predicted, inferred, interpolated, or otherwise determined. For example, the system state can be the input to the approximator to calculate and/or compute the future system state. In examples of predicting a future system state, examples of future system states can include various types of predicted states. Examples of future system states can include a future heat load, temperature (e.g., computing device temperature, chiller fluid temperature, return temperature, supply temperature, ambient temperature, etc.), thermal latency and/or thermal response time, an anticipated power load and/or power consumption, and/or any other suitable system state. The future system state can be for a specific subsystem, specific rack, specific CDU, specific computing device, specific job, and/or any other component.

In variants, the state approximator can determine (e.g., predict, compute, estimate, etc.) a future global system state, average system state, and/or a local system state. In examples of the variants, future local system states can include a future expected return and/or supply temperature of a specific CDU, a temperature of a computing device, an ambient temperature in a specific region of the industrial facility, or any other suitable local system states. In examples, an average system state can include an expected average temperature across a plurality of racks, an expected average return and/or supply temperature of a plurality racks, an expected average temperature of computing devices within a region of the industrial facility, or any other suitable average system state. In examples, a future global system state can include a total expected thermal load of the data center, a total expected power consumption of the computing devices and cooling infrastructure, a global expected temperature distribution across the data center, an expected primary loop return temperature, or any other suitable global system state.

The future state can be a system state that is between 10 seconds and multiple hours into the future (e.g., 10 seconds, 30 seconds, 1 minute, 2 minutes, 5 minutes, 10 minutes, 15 minutes, 30 minutes, 1 hours, 2 hours, 3 hours, 4 hours, 5 hours, 12 hours, or any value and/or range therebetween). The future state can alternatively be less than 10 seconds or greater than multiple hours into the future.

In variants, the state approximator can determine a future state based on job data, physical state information, and/or any other information, as shown for example in FIG. 2. In variants, the state approximator can receive a system state (e.g., power draw, set of return temperatures, supply temperatures, computing device temperatures, chiller temperatures, flow rates, chiller temperatures, ambient temperatures, wetbulb temperature, etc.) as input and compute a future system state based on the system state (e.g., to determine a state-based prediction, etc.). In variants, the input can include a time-series of system states, loads, and/or job data. The approximator can be a time-series forecasting model (e.g., NeuralProphet, autoregressive model, etc.). For example, the input to the approximator can include a set of temperatures from a previous set of time steps. The approximator can predict future temperatures, thermal load, and/or power loads, based on the input. In a specific example, the input can include system states from the past 10 minutes, the past 30 minutes, the past hour, and/or any other suitable amount of time.

In variants, the input to the approximator can include system and/or system component properties and/or hyperparameters. In examples of the variants, properties can include computing device performance limits (e.g. threshold temperature), number of chillers, number of computing devices, types of computing devices, and/or any other properties. Utilizing system properties as input can allow for more accurate predictions by incorporating system-based considerations for determining a future system state. For example, systems with larger amounts of computing devices can have a different future system state (e.g., thermal response, etc.) than a system with less computing devices.

In other variants, the approximator can receive, as input, job information (e.g., job identification, number of jobs, requested resources, allocated resources, etc.) and compute a future system state based on the job information (e.g., to determine a job-based prediction). For example, the approximator can include an autoregressive model that associates heat load with job data. In variants, an autoregressive model can be determined from historical job data and historical heat load data to map trends between jobs and heat load. However, the approximator can be any other suitable model that associates job data with heat load.

In variants, S200 can include determining a hybrid and/or aggregate prediction. In an example, the method can include determining a job-based prediction and a state-based prediction and aggregating the predictions. In another example, the method can include aggregating job-based predictions to determine a total prediction and/or system prediction. In variants, aggregating the predictions can include averaging, weighting, weighted averaging, summing, normalizing, and/or any other steps.

In a specific variant, S200 can include a state approximator that can be a model that represents time-dependent responses (e.g. temperature and/or power consumption) as triangular waveforms, parameterized by slopes, temporal parameters, and/or magnitudes (e.g., triangle model). In these variants, the triangle waveforms can represent accumulation and dissipation of heat and/or increases and decreases in power consumption. In a variant, the triangle model can model a predicted thermal response based on a current system state. For example, the triangle model can illustrate a thermal response based on a current supply temperature, return temperature, and/or other system state. The triangle model can be used to predict a future thermal response by integrating over the triangle model to determine a total expected heat load. In variants, the parameters of the triangle model can be learned or tuned during model training.

In a second specific variant, the model can be a physics-based model. In this variant, the model can include a set of physics-based equations used to compute a future temperature, heat, pressure, and/or any other value. In examples of the second specific variant, equations can include heat transfer equations (e.g., Fourier's law of heat conduction, convective heat transfer equations), fluid dynamics equations (e.g., Navier–Stokes equations), energy balance equations, and thermodynamic relations (e.g., ideal gas law, conservation of energy equations), or any other suitable physics-based equations.

In another specific variant, the model can be a machine learning model where the model is trained to determine a future system based on system state inputs and/or job information. In variants, the machine learning model can include linear layers, convolution layers, max pool layers, attention mechanisms, recurrent layers, normalization layers, activation functions, dropout layers, residual connections, embedding layers, graph convolutional layers, transformer blocks, generative layers, and/or any other suitable machine learning model layer and/or module. However, the state approximator can be any other suitable model.

In variants, different state approximators and/or models can be used to predict future system states for different regions and/or components of the industrial system. In variants, predicting a future system state can include selecting a model based on the future system state of interest. In these variants, the model can be selected from a set of models, each model trained to determine a future system of a specific component, region, and/or subsystem of the industrial facility. In a variant, a specific state approximator can be used to calculate the future system state of a specific component and/or subsystem of the industrial system (e.g., a specific CDU, a specific rack and/or pod, a specific cooling loop, etc.). In an example, each cooling loop can be associated with a control agent that has a state approximator for each component of the cooling loop. In this variant, each state approximator can receive, as input, an associated supply and/or return temperature, and can determine a predicted heat load. Setpoints can be determined for each component based on the heat loads. In another variant, the system can include a heat load predictor and a power load predictor. In variants, the heat load predictor can receive, as input, the predicted power load determined by the power load predictor. In this variant, the heat load is predicted based on power load. However, a plurality of state approximators can be otherwise utilized.

In variants, S200 can include predicting a heat load, power load, and/or any other load for each job received by the system. In variants, each job can be associated with a set of data and/or information. The job can be associated with a job identification, a job name, allocated resources (e.g., CPUs, GPUs, etc.), requested resources (e.g., CPUs, GPUs, etc.), submission time, job status (e.g., scheduled, queued, running, completed, etc.), and/or any other characteristic. In variants, the job information can be encoded (e.g., one-hot encoding, label encoding, ordinal encoding, binary encoding, frequency encoding, etc.). In a first variant, predicting can include inputting the job information and/or job information encodings to the approximator to determine a predicted heat load and/or power load. In a second variant, predicting can include using the job information to recover historical job data (e.g., historical runs of the same job, historical runs of similar jobs, historical runs of the same job type, etc.) and determine (e.g., estimate, etc.) a predicted heat load and/or power load based on the historical job data. For example, in a variant, the method can include receiving historical job data associated with a currently received job. The historical job data can include measured thermal responses, thermal load, power consumption, and/or any other information. In variants, the method can include computing a predicted future state based on the thermal load data. This can be performed using a computational model, statistical model, machine learning model, and/or using any other method. In a third variant, predicting a heat load, power load, and/or any other load can include directly using the requested and/or allocated resources of each job to estimate a power load and/or heat load. For example, a statistical model, look-up table, machine-learning model, and/or other method can be used to map CPUs and/or GPUs to an expected computation load, power load, and/or heat load. In variants, S200 can include predicting a region-level state, rack-level state, machine-level state, global system state, and/or any other state. In variants, predicting a system state can include aggregating job-level predictions based on the region, rack, aisle, pod, and/or location of the allocated resources associated with the job. In variants, predicting a system state can include predicting a future heat load for each job using the job data (e.g., using a machine learning model, etc.) and aggregating the job predictions (e.g., summing, averaging, etc.). For example, all predictions for jobs associated with a specific rack can be summed and/or averaged to determine a rack-level prediction.

However, predicting a future system state S200 may be otherwise performed.

Determining a set of setpoints S300 functions to compute a set of setpoints based on the system state and/or future system state. S300 can be performed after S100 and/or S200. In variants, S300 can be performed periodically, intermittently, continuously, in-response to a request, and/or in any suitable manner. In variants, the execution time of setpoints can be determined (e.g., such that setpoints are scheduled to take effect at specific times, etc.) In a specific example, setpoints can be determined at a specific frequency related to the physical and/or operational constraints of the industrial system. For example, in variants a chiller temperature can only be modified once every hour. Therefore, in this example, a setpoint can be determined once every hour. However, in variants, setpoints can be determined every minute, every 5 minutes, every 10 minutes, every 15 minutes, every 30 minutes, every hour, every 2 hours, every 5 hours, every 10 hours, every 12 hours, or at any range and/or value therebetween. In other variants, setpoints can be determined any time the industrial facility is assigned a new task, job, operation, and/or other assignment. In another variant, setpoints can be determined in response to a sensor measuring a threshold value. For example, setpoints can be determined if a computing device temperature or return temperature exceeds a threshold value. However, setpoints can be determined at any time.

The setpoints can include a chiller on-off state, a chiller setpoint temperature, a flow rate (e.g., supply flow rate, CDU-specific flow rates, etc.), a pressure, a valve position, a fan speed, an ambient air temperature, and/or any other setpoint. The setpoints can be for facility-wide infrastructure, local infrastructures, specific machines, racks, pods, aisles, CDUs, or any other components. For example, CDU-specific setpoints can be determined based on the system states, jobs, and/or computing device operation parameters and/or limits associated with the CDU. In variants, facility agents can determine setpoints for facility-wide components, while local agents can determine setpoints for rack-level components (e.g., CDUs, etc.). For example, a facility agent can be configured to determine setpoints for the HVAC system (e.g., CRAC setpoints, CRAH setpoints, power sources and/or generators, etc.) based on system input (e.g., job data, wetbulb temperature, humidity, etc.) while local agents can be configured to determine rack-level setpoints (e.g., technical loop supply temperature) based on rack-level input (e.g., job data associated the corresponding rack, technical loop temperature measurements, etc.). In variants, S300 can determine the setpoints based on the system state (e.g., determined in S100), predicted future states (e.g., determined in S200), system properties and/or hyperparameters, and/or any other information. In variants, S300 can determine the setpoints based on computing device performance limits (e.g. threshold temperature, T-limits), number of chillers, number of computing devices, types of computing devices, and/or any other properties. For example, setpoints can be determined based on constraints, requirements, and/or conditions established by the structure, architecture, and/or components of the industrial system. In variants, S300 can determine setpoints based on a subset of the system states. For example, in variants setpoints for a specific subsystem or component (e.g., a specific CDU, a specific cooling rack, a specific cooling loop, etc.) may only be determined based on system states associated with that subsystem. In variants, the module for setpoint determination (e.g., agent, control model, decision model, etc.) may only receive (e.g., via transmission, etc.) system states associated with subsystem. However, in other variants, the module can receive the system states of unassociated subsystems, but can otherwise exclude them during determination of setpoints. In variants, S300 can determine setpoints using a model (e.g., a decision model, a decision module, a setpoint-determination model), using heuristics, rules, and/or policies, through optimization of a set of equations and/or constraints based on the system (e.g., minimizing power consumption, minimizing average temperature, maximizing heat absorption, etc.), and/or any suitable method.

The models can include a machine learning model (e.g., neural network, multilayer perceptron model, convolutional neural network, recurrent neural network, etc.), a physics-based model, a statistical model (e.g., linear regression, logistic regression, Poisson regression, time series model, etc.), a probabilistic model, a hybrid model, and/or any other model.

In a first variant, setpoints can be determined based on the predicted physical state of the approximator. In a specific example, the approximator can predict a future heat load. The decision module can compute setpoints (e.g., supply and/or return temperatures, flow rates) that will accommodate and/or absorb the heat load (e.g., using a look-up table, predetermined setpoint-heat load relationships, using physics-based relationships, using a model, etc.).

In a second variant, the setpoints can be determined using a machine learning model. The model can receive, as input, system states (e.g., as determined in S100), predicted future system states (e.g., as optionally determined in S200), and/or system properties and/or constraints, and determine (e.g., compute, calculate, predict, select, etc.) setpoints based off the input. In an example, the system state and predicted system states can be passed through the decision model. The decision model can then produce, as output, a set of setpoints.

In a third variant, when the setpoints are determined using heuristics, rules, and/or policies, a model can include a set of learned and/or predetermined rules and/or policies. In an example, a rule and/or policy can include reducing and/or increasing a setpoint (e.g., temperature, flow rate, pressure, fan speed, etc.) when a system state and/or predicted future system state is determined. However, the method can include using any other suitable rules and/or heuristics. In variants, these rules, heuristics, and/or policies can be manually determined (e.g., using domain knowledge), learned (e.g., through reinforcement learning), and/or otherwise established.

In a fourth variant, when setpoints are determined through optimization, determining can include finding an exact solution to an optimization problem, an optimal solution to an optimization, a sub-optimal solution to the optimization problem, a possible solution to the optimization, and/or any other possible solution. This solution can be determined through a search process (e.g., exhaustive search, branch-and-bound search, etc.), by mathematically solving the optimization problem (e.g. solving a system of equation), by applying a numerical optimization technique (e.g., gradient descent, convex optimization, stochastic optimization, or evolutionary optimization), by employing an approximation or relaxation of the optimization problem, by performing probabilistic inference (e.g., variational inference or Bayesian optimization), or otherwise solved. The optimization problem can include variables, constraints, governing equations, bounds, and/or any other component. For example, the optimization problem can include a set of variables, constraints, and governing equations, that collectively define the industrial system and relate the variables to a target optimization variable. The target optimization variables can include power consumption, temperature (e.g., ambient temperature, component temperatures, average temperatures, supply temperature, return temperatures, etc.), cost, and/or any other target optimization variable. In these variants, setpoints can be variables of the optimization problem that can be determined (e.g., solved for) in order to optimize (e.g., minimize, maximize, etc.) the target optimization variable. In a specific variant, S300 can include determining the setpoints for a primary chiller loop by minimizing a number of chiller used (e.g., current, future, etc.) and/or maximizing a chiller temperature (e.g., current, future, etc.) required to handle a predicted heat load (e.g., determined from the approximator, etc.). This optimization can have the benefit of minimizing power consumption during operation of the industrial facility.

However, determining a set of setpoints S300 may be otherwise performed.

Controlling the system S400 functions to operate the industrial system using the setpoints and/or the predictions (e.g., determined in S300 and S200). S400 can be performed after setpoints are determined (e.g., in S300) or after predictions are determined (e.g., in S200). S400 can include controlling one or more physical or virtual components of the industrial system (e.g., machinery, actuators, valves, motors, heaters, chillers, pumps, control modules, software-defined subsystems, etc.). In variants, S400 can include controlling the job scheduling services for job scheduling, allocating, and/or any other tasks. S400 can be performed in real-time, near-real-time, at a scheduled time, in response to a trigger, or at any other time. However, S400 can include any other suitable steps.

In variants, controlling the system S400 includes controlling the facility infrastructure S410; controlling the IT infrastructure S420, and/or otherwise controlling the system.

Controlling the facility infrastructure S410 functions to control the facility infrastructure (e.g., chiller, cooling systems, etc.) based on setpoints and/or predictions. In a first embodiment, controlling the system based on setpoints can include controlling the cooling systems and/or facility infrastructure. System control setpoints and/or commands can be sent through a supervisory control and data acquisition (SCADA) system, distributed control system (DCS), programmable logic controllers (PLCs), edge devices, cloud-based control software, or any suitable control architecture. Controlling the facility based on setpoints can include turning on-and-off chillers, changing actuator positions, motor speeds, fan speeds, fluid flow rates (e.g., supply flow rate, individual CDU flow rates), temperature setpoints (e.g., chiller temperatures, ambient air temperatures), and/or any other operational parameters based on the setpoints. In a second embodiment, the facility infrastructure can be controlled by turning on, deploying, and/or activating resources (e.g., power supply, power generators, etc.), and/or shutting them off. In variants, thermal load and/or power consumption predictions (e.g., made in S200) can be used to activate the resources. In examples of the second embodiment, resources can include chillers, fans, power supplies (e.g., batteries, turbines, piston engines, etc.), and/or any other component. A resource can be activated (e.g., turned on, deployed, utilized, etc.) when a prediction that exceeds a threshold is determined. For example, if a set of jobs is predicted to have a total power consumption that exceeds the current available resources, a power supply can be turned on. In variants, power supply deployment can be instantaneous, substantially instantaneous, rapid, or have any other temporal property. In another example, if a set of jobs is predicted to have a thermal load that is unable to be currently supported, a chiller and/or fan of the facility can be deployed to provide additional cooling capabilities (e.g., in anticipation of running the jobs). In variants, the chiller and/or fans can be turned on in advance of running the job (e.g. 10 seconds early, 20 seconds early, 30 seconds early, 1 minute early, 5 minutes early, 10 minutes early, 20 minutes early, 30 minutes, 1 hour early, and/or any suitable value and/or range therebetween), to pre-cool the system. In variants, S410 can be continuous (closed-loop control) or intermittent (open-loop with periodic optimization updates). In variants, S410 can include terminating a set of jobs in which setpoints were determined (e.g., cancelled, timed out, completed, etc.). In these variants, power resources, cooling resources, and/or computational resources may be automatically reduced or reallocated to other computational resources. In variants, this can be enabled by controlling the system according to a set of previously determined setpoints, determining new setpoints, and/or otherwise controlling the system.

However, controlling the facility infrastructure S410 may be otherwise performed.

Controlling the IT infrastructure S420 functions to control the IT infrastructure (e.g., computing device, GPUs, CPUs, etc.) via job allocation and/or scheduling based on the predictions. In variants, S420 can include controlling job allocation and/or scheduling based on the future system state predictions (e.g., made in S200). S420 can include controlling job allocation and scheduling, which can include delaying job, changing the priority of jobs, changing the order of jobs, allocating jobs to different machines, racks, and/or pods, and/or any other suitable task. In variants, S420 can include allocating, scheduling, delaying, postponing, and/or otherwise controlling jobs based on their anticipated thermal and/or power load. In a specific example, S420 can include determining jobs with high power and/or thermal loads (e.g., through prediction in S200) and delaying the jobs if the resources are currently unavailable. In another specific example, S420 can include allocating job with thermal loads to racks and/or pods that have available cooling resources (e.g., due to pre-cooling, due to having finished a job with a high thermal load, etc.). In another variant, jobs can be allocated to computing devices in regions (e.g., racks, aisles, rooms, etc.) of the facility that have cooler local temperatures than other regions of the facility or regions with larger heat rejection capacity. For example, jobs can be allocated to devices in locations that are cooler than an average temperature and/or median temperature of the facility. In another example, jobs can be allocated to devices in location that have larger heat rejection capacity (e.g., than a median and/or average capacity, then a predetermined limit and/or threshold, etc.). In variants, S420 can include executing jobs based on a prioritization order. In variants, the prioritization order can be based on a predicted heat load and/or power load of a job. Additionally and/or alternatively, the prioritization order can be based on a state of the data center (e.g., local temperatures, available resources, etc.). In an example, jobs with higher predicted power loads and/or heat loads have lower priority when a data center has a limited amount of computational and/or cooling resources. In this example, jobs with predicted heat loads that cannot be absorbed by the available cooling resources (e.g., cannot be absorbed by the capacity of the available cooling resources, number of cooling resources, volume of cooling resources, etc.) can be de-prioritized. The available cooling resources can be determined based on a look-up table, historical data, a predictive model, or any other suitable process. The predicted available cooling resources can be compared with a predicted heat load of a job to determine whether or not the cooling resources can absorb the heat. The prioritization order can be determined manually, based on policies, rules, and/or heuristics, and/or any other suitable method. However, S420 can alternatively include controlling job allocation and scheduling in other ways.

However, controlling the IT infrastructure S420 may be otherwise performed.

However, controlling the system S400 may be otherwise performed.

The method can optionally include training the models used by the agents S1000, which functions to determine coefficients and/or parameters of the models (e.g., approximator, decision model, etc.). S1000 can be performed periodically, intermittently, in-response to a request, sporadically, continuously (e.g., if the model is a reinforcement learning model, etc.) and/or at any suitable frequency. The models can be trained offline (e.g. pre-trained, trained on external system), online, a combination thereof, or otherwise trained. S1000 can use supervised training, unsupervised training, reinforcement learning, and/or any suitable method. S1000 can use historical data, synthetic data, and/or any suitable data for training the model. In a variant of the predictive model and/or approximators, S1000 can include training data that includes a set of system states with the training target being a future system state (e.g., future temperature, heat load, thermal response, etc.). In variants, the training data can also include system and/or component properties. In these variants, the model can be trained to predict a future state based on the components, architecture, structure, location within the industrial facility, and/or any other suitable facility property. In other variants, S1000 can include learning the coefficients of the predictive model and/or approximators via reinforcement learning. In these variants, the reward and/or penalty signal for the reinforcement learning can include deviations in the supply and/or return temperature. In an example, the approximator can predict a heat load and the decision module can compute setpoints based on the heat load. If a measured supply temperature deviates from an expected value, the approximator can be penalized and/or the coefficients can be tuned. In another variant, the reward and/or penalty signal can include deviation between the computing device temperature and a temperature limit and/or threshold (e.g., T-limit). Policies can be learned through reinforcement learning algorithms, policy gradient, proximal policy optimization, and/or any other suitable method. In variants, the method can include training multiple models and/or approximators. An approximator can be trained for every component and/or machine of a system (e.g., rack, CDU, computing device, etc.)Training multiple models (e.g., based on components, architecture, structure, location, etc.) can result in increased accuracy by ensuring that each model learns the patterns, trends, and/or behaviors of specific subsystems, components, and/or regions within the industrial facility. Training the models in S1000 can include performing gradient descent, stochastic optimization, evolutionary optimization, reinforcement learning, probabilistic inference, Bayesian inference, least-squares fitting or any other method to tune coefficients, parameters, weights, and/or any suitable values of the models. In one specific example in which the approximator is a triangle model, the parameters (e.g., slopes, magnitudes, temporal parameters, etc.) of the triangle waveform can be determined during S1000 and/or learned. In other examples, S1000 can include tuning the coefficients and/or weights of a multi-layer perceptron model to determine the future system state. However, the models can be otherwise trained.

However, training the models used by the agents S1000 may be otherwise performed.

The models can use classical or traditional approaches, machine learning approaches, and/or other approaches. The models can include regression (e.g., linear regression, non-linear regression, logistic regression, etc.), decision tree, LSA, clustering, association rules, dimensionality reduction (e.g., PCA, t-SNE, LDA, etc.), neural networks (e.g., CNN, DNN, CAN, LSTM, RNN, encoders, decoders, deep learning models, transformers, etc.), ensemble methods, optimization methods, classification, rules, heuristics, equations (e.g., weighted equations, etc.), selection (e.g., from a library), regularization methods (e.g., ridge regression), Bayesian methods (e.g., Naiive Bayes, Markov), instance-based methods (e.g., nearest neighbor), kernel methods, support vectors (e.g., SVM, SVC, etc.), statistical methods (e.g., probability), comparison methods (e.g., matching, distance metrics, thresholds, etc.), deterministics, genetic programs, and/or any other suitable architecture. The models can include (e.g., be constructed using) a set of input layers, output layers, and hidden layers (e.g., connected in series, such as in a feed forward network; connected with a feedback loop between the output and the input, such as in a recurrent neural network; etc.; wherein the layer weights and/or connections can be learned through training); a set of connected convolution layers (e.g., in a CNN); a set of attention layers (e.g., cross-attention layers, self-attention layers, etc.); and/or have any other suitable architecture. The models can include less than 10, tens, hundreds, thousands, tens of thousands, hundreds of thousands, and/or any other number of parameters (e.g., weights, biases, etc.). The models can extract data features (e.g., feature values, feature vectors, high-dimensional features, embeddings in a high-dimensional space with hundreds or thousands of dimensions, human-unintelligible features, etc.) from the input data, and determine the output based on the extracted features. However, the models can otherwise determine the output based on the input data.

Models can be trained, learned, fit, predetermined, and/or can be otherwise determined. The models can be trained or learned using: supervised learning, unsupervised learning, self-supervised learning, semi-supervised learning (e.g., positive-unlabeled learning), reinforcement learning, transfer learning, Bayesian optimization, fitting, interpolation and/or approximation (e.g., using gaussian processes), backpropagation, and/or otherwise generated. The models can be learned or trained on: labeled data (e.g., data labeled with the target label), unlabeled data, positive training sets (e.g., a set of data with true positive labels, negative training sets (e.g., a set of data with true negative labels), and/or any other suitable set of data.

Any model can optionally be validated, verified, reinforced, calibrated, or otherwise updated based on newly received, up-to-date measurements; past measurements recorded during the operating session; historic measurements recorded during past operating sessions; or be updated based on any other suitable data.

Any model can optionally be run or updated: once; at a predetermined frequency; every time the method is performed; every time an unanticipated measurement value is received; or at any other suitable frequency. Any model can optionally be run or updated: in response to determination of an actual result differing from an expected result; or at any other suitable frequency. Any model can optionally be run or updated concurrently with one or more other models, serially, at varying frequencies, or at any other suitable time.

### Specific Examples

Specific Example 1. A method comprising: receiving a set of job data associated with a set of compute jobs for a data center, wherein the data center comprises a set of computing devices and a set of chillers; based on the set of job data, predicting a set of heat loads associated with the set of jobs for a future timestep; and based on the predicted set of heat loads, determining a set of chiller setpoints for the set of chillers, wherein the set of chillers is controlled based on the set of chiller setpoints.

Specific Example 2. The method of Specific Example 1, wherein predicting a set of heat loads comprises predicting a job-level heat load for each job of the set of jobs, wherein the set of chiller setpoints are determined based on an aggregation of the job-specific heat loads.

Specific Example 3. The method of Claim 1, further comprising staging a set of power sources based on the predicted power load.

Specific Example 4. The method of Claim 1, wherein the set of jobs are allocated to a subset of computing devices, wherein the subset of computing devices is selected based on a location of the set of computing devices within the data center, wherein a location of the set of computing devices has a heat rejection capacity that is larger than a predetermined heat rejection capacity limit

Specific Example 5. The method of Specific Example 1, wherein controlling the set of chillers according to the set of chiller setpoints is performed prior to executing the set of jobs.

Specific Example 6. The method of Specific Example 1, wherein predicting the set of heat loads associated with the set of jobs comprises first predicting a set of power loads based on the set of job data and then predicting the set of heat loads based on the set of power loads.

Specific Example 7. The method of Specific Example 1, wherein determining the set of chiller setpoints comprises determining a minimum number of on-state chillers and a maximum chiller temperature needed to absorb the predicted set of heat loads.

Specific Example 8. The method of Specific Example 1, wherein the method further comprises determining a prioritization order of the set of jobs based on the predicted heat loads, wherein the method further comprises executing the set of jobs according to the prioritization order.

Specific Example 9. The method of Specific Example 8, wherein the prioritization order is further based on a capacity of available cooling resources.

Specific Example 10. The method of Specific Example 9, wherein determining a prioritization order comprises de-prioritizing jobs that have a predicted heat load that cannot be absorbed by the available cooling resources.

Specific Example 11. The method of Specific Example 1, wherein the set of job data comprises a number of requested resources for each job of the set of jobs.

Specific Example 12. The method of Specific Example 1, wherein the method further comprises determining an execution time for each setpoint of the set of chiller setpoints, wherein determining an execution time for each setpoint of the set of chiller setpoints comprises ensuring that the execution times of each setpoint occur at a frequency lower than a chiller setpoint frequency limit.

Specific Example 13. The method of Specific Example 1, wherein predicting a set of heat loads is further based on a season and a set of historical load data.

Specific Example 14. The method of Specific Example 1, further comprising predicting a confidence interval for each heat load of the predicted set of heat loads using a neural network.

Specific Example 15. The method of Specific Example 1, further comprising, when the set of jobs are terminated, retrieving a set of previously determined chiller setpoints, wherein the set of chillers are controlled based on the set of previously determined setpoints.

Specific Example 16. The method of Specific Example 1, further comprising predicting a set of state-based heat loads based on a physical state of the data center, wherein determining the set of chiller setpoints for the set of chillers is further based on the set of state-based heat loads.

Specific Example 17. A system comprising: (I) an agent for an industrial system, wherein the industrial system comprises a set of computing devices, a set of cooling resources thermally connected to the set of computing devices, and a set of power sources electrically connected to the set of computing devices, wherein the agent comprises a power load predictor and a heat load predictor; (II) a job scheduler configured to: (a) receive a set of jobs to be executed by the set of computing devices; (b) receive a set of predicted power loads from the power load predictor, wherein the set of predicted power loads is determined based on the set of jobs; (c) receive a set of predicted heat loads from the heat load predictor, wherein the set of predicted heat loads is determined based on the set of power loads; and (d) allocate the set of jobs to the set of computing devices based on the set of predicted power loads and the set of predicted heat loads; and wherein the agent is configured to determine a set of cooling setpoints based on the set of predicted heat load, wherein the cooling resources are controlled based on the set of cooling setpoints and the power sources are staged based on the predicted power loads.

Specific Example 18. The system of Specific Example 17, wherein the heat load predictor comprises an autoregressive model, wherein the autoregressive model is determined using a set of historical job data and historical heat load data.

Specific Example 19. The system of Specific Example 17, wherein the job scheduler is further configured to determine a prioritization order of the set of jobs based on the predicted heat loads, wherein determining the prioritization order comprises de-prioritizing jobs that have a predicted heat load that cannot be absorbed by a set of available chillers.

Specific Example 20. The system of Specific Example 17, wherein the set of predicted power loads comprises a set of job-level power loads, wherein each job-specific power load is determined based on job data associated with each job of the set of jobs.

All references cited herein are incorporated by reference in their entirety, except to the extent that the incorporated material is inconsistent with the express disclosure herein, in which case the language in this disclosure controls.

As used herein, "substantially" or other words of approximation can be within a predetermined error threshold or tolerance of a metric, component, or other reference, and/or be otherwise interpreted.

Optional elements, which can be included in some variants but not others, are indicated in broken line in the figures. However, unbroken lines in the figures should not be interpreted to indicate that the depicted elements are essential, nor to indicate that the depicted elements may not be omitted from variants of the invention.

Different subsystems and/or modules discussed above can be operated and controlled by the same or different entities. In the latter variants, different subsystems can communicate via: APIs (e.g., using API requests and responses, API keys, etc.), requests, and/or other communication channels. Communications between systems can be encrypted (e.g., using symmetric or asymmetric keys), signed, and/or otherwise authenticated or authorized.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

We claim:

1. A method comprising
° receiving a set of job data associated with a set of compute jobs for a data center, wherein the data center comprises a set of computing devices and a set of chillers;
° based on the set of job data, predicting a set of heat loads associated with the set of jobs for a future timestep; and
° based on the predicted set of heat loads, determining a set of chiller setpoints for the set of chillers, wherein the set of chillers is controlled based on the set of chiller setpoints.

2. The method of claim 1, wherein predicting a set of heat loads comprises predicting a job-level heat load for each job of the set of jobs, wherein the set of chiller setpoints are determined based on an aggregation of the job-specific heat loads.

3. The method of claim 1, further comprising staging a set of power sources based on the predicted power load.

4. The method of claim 1, wherein the set of jobs are allocated to a subset of computing devices, wherein the subset of computing devices is selected based on a location of the set of computing devices within the data center, wherein a location of the set of computing devices has a heat rejection capacity that is larger than a predetermined heat rejection capacity limit.

5. The method of claim 1, wherein controlling the set of chillers according to the set of chiller setpoints is performed prior to executing the set of jobs.

6. The method of claim 1, wherein predicting the set of heat loads associated with the set of jobs comprises first predicting a set of power loads based on the set of job data and then predicting the set of heat loads based on the set of power loads.

7. The method of claim 1, wherein determining the set of chiller setpoints comprises determining a minimum number of on-state chillers and a maximum chiller temperature needed to absorb the predicted set of heat loads.

8. The method of claim 1, wherein the method further comprises determining a prioritization order of the set of jobs based on the predicted heat loads, wherein the method further comprises executing the set of jobs according to the prioritization order.

9. The method of claim 8, wherein the prioritization order is further based on a capacity of available cooling resources.

10. The method of claim 9, wherein determining a prioritization order comprises de-prioritizing jobs that have a predicted heat load that cannot be absorbed by the available cooling resources.

11. The method of claim 1, wherein the set of job data comprises a number of requested resources for each job of the set of jobs.

12. The method of claim 1, wherein the method further comprises determining an execution time for each setpoint of the set of chiller setpoints, wherein determining an execution time for each setpoint of the set of chiller setpoints comprises ensuring that the execution times of each setpoint occur at a frequency lower than a chiller setpoint frequency limit.

13. The method of claim 1, wherein predicting a set of heat loads is further based on a season and a set of historical load data.

14. The method of claim 1, further comprising predicting a confidence interval for each heat load of the predicted set of heat loads using a neural network.

15. The method of claim 1, further comprising, when the set of jobs are terminated, retrieving a set of previously determined chiller setpoints, wherein the set of chillers are controlled based on the set of previously determined setpoints.

16. The method of claim 1, further comprising predicting a set of state-based heat loads based on a physical state of the data center, wherein determining the set of chiller setpoints for the set of chillers is further based on the set of state-based heat loads.

17. A system comprising:
° an agent for an industrial system, wherein the industrial system comprises a set of computing devices, a set of cooling resources thermally connected to the set of computing devices, and a set of power sources electrically connected to the set of computing devices, wherein the agent comprises a power load predictor and a heat load predictor;
° a job scheduler configured to:
° receive a set of jobs to be executed by the set of computing devices;
° receive a set of predicted power loads from the power load predictor, wherein the set of predicted power loads is determined based on the set of jobs;
° receive a set of predicted heat loads from the heat load predictor, wherein the set of predicted heat loads is determined based on the set of power loads; and
° allocate the set of jobs to the set of computing devices based on the set of predicted power loads and the set of predicted heat loads; and
wherein the agent is configured to determine a set of cooling setpoints based on the set of predicted heat load, wherein the cooling resources are controlled based on the set of cooling setpoints and the power sources are staged based on the predicted power loads.

18. The system of claim 17, wherein the heat load predictor comprises an autoregressive model, wherein the autoregressive model is determined using a set of historical job data and historical heat load data.

19. The system of claim 17, wherein the job scheduler is further configured to determine a prioritization order of the set of jobs based on the predicted heat loads, wherein determining the prioritization order comprises de-prioritizing jobs that have a predicted heat load that cannot be absorbed by a set of available chillers.

20. The system of claim 17, wherein the set of predicted power loads comprises a set of job-level power loads, wherein each job-specific power load is determined based on job data associated with each job of the set of jobs.
